(19) United States
(12) Patent Application Publication
(10) Pub. No.: US 2016/0335296 A1
(43) Pub. Date: Nov. 17, 2016

(54) Memory System for Optimized Search Access

(71) Applicant: Blue Sage Communications, Inc., San Ramon, CA (US)

(72) Inventors: Satish Sathe, San Ramon, CA (US); Shing Sheung Tse, Milpitas, CA (US); Jitendra Khare, San Jose, CA (US)

(21) Appl. No.: 14/711,910

(22) Filed: May 14, 2015

(51) Int. Cl. G06F 17/30

(52) U.S. Cl. CPC G06F 17/30324; G06F 17/30327; G06F 17/30867

(57) ABSTRACT

A memory system and search method are provided for searching a multi-field longest prefix match (LPM) in a search term. The method provides a first LPM rule memory, where an LPM rule includes explicitly defined bit values in at least the n most significant bit (MSB) positions in a field of digital information, where n is an integer greater than or equal to 0. The method accepts a search term and compares at least a first field in the search term to subset rules structured in a sorted search tree for a first field organized as a LPM rule in the first LPM memory. When an explicit match is not found to the subset rules, the first field in the search term is compared to superset rules for the first field in the first LPM memory. As a final step, the method performs an instruction associated with a matching rule.

### BACKGROUND OF THE INVENTION

1. Field of the Invention

This invention generally relates to non-transitory memory optimization and, more particularly to a system and method for structuring memories in a manner to optimize memory searching.

2. Description of the Related Art

There are perhaps billions of network-connected computer devices that communicate with each other. Communication requires that networks figure out how to forward packets of information to the correct destination. Different communication types have different processing requirements associated with latency, bandwidth, and quality of service (QoS). An increase in viruses and attacks means traffic must be monitored and malicious devices or connections prevented. Security protocols such as IPSec require identification of a database associated with packet. End stations that initiate communication require identification of a connection associated with packet. Networks need header manipulation when forwarding packets and need to identify databases. Networks also need to provide the correct quality of service to customers and have to identify packets that belong to customers. Further, technology trends such as software defined networking (SDN) and network functions virtualization (NFV) are moving towards reconfigurable platforms that can be retargeted. This flexibility means network hardware must be flexible and capable of handling any type of traffic, which increases search string size as all header fields could be required for processing.

FIG. 1 is a depiction of an AVL tree (prior art). An (Adelson-Velskii and Landis') AVL tree is a self-balancing binary search tree where rules are arranged in a sorted manner with all rules with a value less than the current rule are stored in one (left) subtree and all rules with a value greater than the current rule are stored in the other (right) subtree. In an AVL tree, the height of the two subtrees must not differ by more than one at each rule. AVL trees are used because entries can be added and deleted very efficiently. The circled entries could be missing and the tree would still be a balanced AVL tree because the height of the left and right subtrees from each entry is within one of each other.

FIG. 2 is a depiction of a binary tree (prior art). A binary tree is a tree where rules are arranged in a sorted manner and all rules with a value less than the current rule are stored on one (left) subtree and all rules with a value greater than the current rule are stored in the other (right) subtree. In a binary tree, the number of rules in each of the two subtrees must not differ by more than one at each rule.

Linear Search: A search technique where rules are searched sequentially from a starting point in the table to an ending point. The rules in the table do not require any ordering since they are searched sequentially.

FIG. 3 is a depiction of a cross product trie search (prior art). A cross product trie search is a search technique where a large search string is divided into smaller substrings and each substring is searched independently and in parallel until a matching result is found for that substring. The results of two or more of the substring searches are then concatenated and the combined substring is then searched until a matching result is found for the combination. This process is followed recursively until all substring search results have been combined and a final result found.

FIG. 4 is a depiction of a hierarchical trie search (prior art). A hierarchical trie search is a search technique where a large search string is divided into smaller substrings and the starting substring is searched first to find a matching result. This result is used as the starting point for a search in a subsequent substring that contains all the rules that have the specific value found in the first substring. This process is followed recursively until the last substring is processed.

FIG. 5 is a depicting of a backtracking search process (prior art). Backtracking is a situation in which a hierarchical trie search must return to a previously searched substring and traverse a different subtree because multiple rules matched the search string in the previous substring. In this case, a search string AAAA_BBBB_CCCC_DDFF does not match rule 0: AAAA_BBBB_CCCC_DDDD but does match rule 1: AA**_BB**_CC**_DD**. The symbol “*” is referred to herein as a wildcard or wild card, and it may have any possible value. Here, the search string and rules are populated by symbols (e.g., A or *) that may represent a single binary bit (e.g., 1 or 0) or a combination of binary bits. In many of the examples used herein the symbols are hexadecimal numbers (i.e. a sequence of 4 binary bits). If the search process traversed the subtree rooted at AAAA then it would only notice that it mismatches rule 0 when searching in substring 4 (DDDD). It then has to backtrack to substring 1 to find that AA** also matches and the actual matching rule is rule 1: AA**_BB**_CC**_DD**.

FIG. 6 is a diagram depicting the process of bit map vectoring (prior art). Bit map vectoring is a technique that minimizes rule expansion in string searches by passing forward a bit vector that contains a bit corresponding to each rule in the table. The bits corresponding to all rules that match the search substring are set in the bit vector that is passed forward to the next substring. In this example, instead of traversing a subtree of rules that start with AAAA and a separate tree of rules that start with AA** (as in FIG. 5), a bit vector is assigned to a search indicating that a search string AAAA matches both rule 0 and rule 1. A separate vector is generated at each substring. At the end of all substrings, a logical AND function is performed for each bit in the bit vector. If the result of the AND is a set bit, then the corresponding rule matches the search string. If multiple rules match, some prioritization scheme is used to determine which rule out of all matching rules to select as the best matching rule.

For search string AAAA_BBBB_CCCC_DDDF, the bit vector for the last substring will only have bit 1 set since the substring matches DD**, but not DDDD. Thus, the only rule that has its corresponding bit set in all substrings is rule 1, the correct matching rule. Note that this technique can be used by both the cross product trie as well as the hierarchical trie.

Longest Prefix Match (LPM) Rule: A type of rule where the wild card bits start from a most significant bit of a tuple and extend contiguously to the least significant bit of that tuple. For example a rule that contains the value AA** is an LPM rule because the 8 least significant bits (LBSs) are wild cards.

Exact Match (EM) Rule: A type of rule where all the bits have a specific value. For example, a rule that contains the value AAAA is an EM rule because all bits have a specific value.

Access Control List (ACL) Rule: A type of rule where the wildcard bits are in random non-contiguous positions. For example a rule that contains the value *A*A is an ACL rule because the wild card bits are not contiguous.

Tuple: An ordered list of fields that constitute the rule string. Each tuple is typically one header field in a packet. For example, a particular rule set may consist of a 5-tuple made up of the IP Destination Address, IP Source Address, TCP Destination Port Number, TCP Source Port Number, and IP Protocol field.

Ternary Content Addressable Memory (TCAM) and existing algorithmic search techniques suffer from the problems of requiring a large area (memory), high power dissipation, long search latencies, and they do not scale efficiently to large rule strings and large table sizes. Further, TCAM cannot detect random bit errors and can give incorrect results if such an error occurs. These methods require rule reshuffling and ordering when rules overlap. Finally, their function is fixed and associated random access memory (RAM) cannot be repurposed or shared with other functions.

Other problems include the capability of only returning one result per search, and conventional methods cannot provide additional table information such as whether a rule already exists in the table. Further, they cannot provide information such as which and how many rules overlap with a particular rule. They do not support virtual partitions where the database can be partitioned into multiple independent tables, and they have restricted result ordering.

Finally, the use of conventional methods typically results in rule expansion, and they cannot handle rules with random wildcards or multiple tuples. External databases and high performance processors are required for rule updates, and even so, rule and table updates are slow.

It would be advantageous if the above-mentioned problems associated with conventional search methods could be addressed by optimizing the manner in which rules are stored and accessed.

### SUMMARY OF THE INVENTION

Disclosed herein are a rule access system and method that simplify table management, reduce rule expansion and resource overhead, and maximize performance in a process that compares a search term, such as packet overhead fields, to a plurality of rules stored in memory. Once a rule is matched to the search term, instructions associated with the rule can be accessed, and the search term processed in response to the instructions. Using elements of conventional hierarchical tries and sorted search trees, separate overlapping vs. non-overlapping rules permit a new form of bit map vectoring that supports the reordering of search substrings. As such, rules can be completely independent of each other, and a significant number of substrings may include wildcards. In short, the starting point of a search can be reordered so that the search begins by looking for a substring with exact matching value, but in the event that an exact match is not found, is able to loop back to substrings with wildcards. Thus, the rule reordering limits the need for numerous parallel searches and associated rule expansion.

Accordingly, a method is provided of searching for a multi-field longest prefix match (LPM) in a search term. The method provides a non-transitory first LPM rule memory, where an LPM rule includes explicitly defined bit values in at least the n most significant bit (MSB) positions in a field of digital information, where n is an integer greater than or equal to 0. The method accepts a search term and compares at least a first field in the search term to subset rules structured in a sorted search tree (e.g., Adelson-Velskii and Landis' (AVL)) for a first field organized as a LPM rule in the first LPM memory. As used herein, a subset rule is defined by a substring with at least one explicitly specified digital value that distinguishes the substring from every other rule substring in the first LPM memory. When an explicit match is not found to the subset rules, the first field in the search term is compared to superset rules for the first field in the first LPM memory. As used herein, a superset rule is defined as a substring with a least one wildcard more than an associated subset rule, and having a digital value overlapping the associated subset rule digital value, where a wildcard may be any digital value. As a final step, the method performs an instruction associated with a matching rule. For example, if the search term is a destination address in a packet header, the instruction performed may be to change the destination address and send the packet to that address.

More explicitly, the first LPM rule memory includes a first subset rule having a digital value overlapping a first superset rule, where the first subset rule and first superset rule have associated locations in the first LPM rule memory. The first LPM memory may also include a second subset rule having a digital value overlapping the first superset rule, where the second subset rule and first superset rule have associated locations in the first LPM rule memory. In one aspect, the second superset rule has at least one more wildcard than the first superset rule, and the second superset rule and first superset rule have associated locations in the first LPM rule memory.

For example, the first subset rule may have at a first location in the first LPM memory, represented as a first mask word with explicitly defined digital values and the position of wildcards in the first subset rule. The first location also includes a pointer directed to a second location. The first superset rule is located at the second location in the first LPM memory, represented as a second mask word with explicitly defined digital values and the position of wildcards in the first superset rule. The second subset rule has a third location in the first LPM memory, represented as a third mask word with explicitly defined digital values and the position of wildcards in the second subset rule. The third location also includes a pointer directed to a fourth location. The first superset rule (i.e. a copy of the first superset rule) is located at the fourth location in the first LPM memory, represented as a second mask word with explicitly defined digital values and the position of wildcards in the first superset rule.

Alternatively, to minimize rule expansion, the first subset rule and first superset rule may be collocated in a first LPM memory location, represented as a first mask word with explicitly defined digital values and the position of wildcards in the first subset rule and the first superset rule. Likewise, the second subset rule and first superset rule may be collocated in a second LPM memory location, represented as a second mask word with explicitly defined digital values and the position of wildcards in the second subset rule and the first superset rule.

The step of comparing the search term to the subset rules may include the following substeps. A matching rule is acknowledged when all bits in the search term match the explicitly defined bits in a subset rule. However, when all the bits in the search term fail to match the explicitly defined bits in a first subset rule, the number of explicitly matching bits are counted to create a current count and compared to a previously stored count. If the current count is greater than the previously stored count, the previously stored count is replaced with the current count and the first subset is stored in a reconciliation memory. Then, the next subset rule in the first LPM rule memory sorted search tree is accepted for comparison to the search term. Subsequent to comparing all the subset rules in the first LPM memory to the search term, and not finding a match, the subset rule in the reconciliation memory is accessed. If the above-described pointer location method is used, a pointer is read directed to an associated superset rule. The search term is masked with wildcards from the associated superset rule, and if the unmasked bits in the search term match the associated superset rule, the associated superset rule is acknowledged as the matching rule.

Alternatively, if the above-described collocation method is used, the subset rule in the reconciliation memory is accessed subsequent to comparing all the subset rules in the first LPM memory to the search term and not finding a match. The search term is masked with wildcards from a collocated superset rule, and if the unmasked bits in the search term match the collocated superset rule, the collocated superset rule is acknowledged as the matching rule.

Typically, a non-transitory second LPM rule memory is provided with subset rules, structured in a sorted search tree for a search term second field organized as a LPM rule, and with superset rules for the second field. Then, subsequent to comparing the first field of the search term, a second field in the search term is compared to subset rules in the second LPM memory. If an explicit match is not found to the subset rules in the second LPM rule memory, the second field in the search term is compared to the superset rules in the second LPM memory, in the manner in which the first field of the search term was processed. Then, instructions are performed in response to determining a matching rule found in the second LPM memory.

Additional details of the above-described method and a memory system organized for optimized multi-field LPM search accessing are provided below.

### BRIEF DESCRIPTION OF THE DRAWINGS

FIG. 1 is a depiction of an AVL tree (prior art).

FIG. 2 is a depiction of a binary tree (prior art).

FIG. 3 is a depiction of a cross product trie search (prior art).

FIG. 4 is a depiction of a hierarchical trie search (prior art).

FIG. 5 is a depicting of a backtracking search process (prior art).

FIG. 6 is a diagram depicting the process of bit map vectoring (prior art).

FIG. 7 is a schematic block diagram of a memory system organized for optimized multi-field longest prefix match (LPM) search accessing.

FIG. 8 is a diagram depicting an exemplary first subset rule, second subset rule, first superset rule, and second superset rule.

FIG. 9 is a schematic block diagram depicting a variation of the system of FIG. 7.

FIG. 10 is a depiction of exemplary mask words.

FIG. 11 is a schematic block diagram of the systems of FIGS. 7 and 9 with additional components.

FIG. 12 is a diagram depicting the search process divided into three stages.

FIG. 13 is a diagram depicting the results of a cross product search.

FIG. 14 depicts an exemplary tree structure.

FIG. 15 is a drawing depicting an exemplary tree with reduced rule expansion.

FIG. 16 depicts a table with overlapping rule pointers.

FIG. 17 is a drawing depicting the table of FIG. 16 where the subset rules are searched before superset rules.

FIG. 18 is a diagram depicting a table with a compressed representation of superset rules.

FIG. 19 is a diagram depicting an additional compression technique.

FIG. 20 is a depiction of a table where the subset rules include extra information to indicate the existence of an overlapping superset rule.

FIG. 21 is a diagram depicting the releveling of an AVL tree.

FIG. 22 is a diagram depicting a hierarchical search approach where a subsequent substring tree contains all the rules that overlapped each other in a previous substring.

FIG. 23 is a diagram depicting the merger of overlapping rules into a single tree.

FIG. 24 is a diagram depicting multi-level hashing.

FIG. 25 is a diagram depicting the process of reconciliation.

FIG. 26 is a diagram presenting another example of overlapping LPM rules.

FIG. 27 is a diagram depicting an example of two non-overlapping LPM rules—AAAA_CCCC and AABB_CCCC, and one more rule AAB*_**** that overlaps rule AABB_CCCC.

FIG. 28 is a diagram showing an example of one rule that overlaps two rules.

FIG. 29 is a diagram depicting the merger of superset pointers made in order to reduce rule expansion.

FIG. 30 depicts an example of a table that has a superset overlapping rule (AA**_EEEE) that overlaps two non-overlapping rules (AAAA_CCCC and AABB_DDDD in the first substring.

FIG. 31 is a diagram depicting another example of an exemplary third stage process that avoids the use of bit map vectoring.

FIG. 32 is a diagram depicting ambiguity that is possibly created by searching for all subset rules prior to searching for superset rules.

FIG. 33 is a first flowchart illustrating a method of searching for a multi-field LPM in a search term.

FIG. 34 is a second flowchart illustrating method of searching for a multi-field LPM in a search term.

FIGS. 35A through 35D are examples depicting the benefit of third stage processing.

### DETAILED DESCRIPTION

Overlapping Rules: Two rules are considered overlapping when there exists at least one string encoding that can match both rules. This is possible because rules can have wildcards in them. For example, the rules AAAA and AA** are considered overlapping because a search string AAAA will match both rules.

Non-overlapping Rules: Two rules are considered non-overlapping if it is not possible to have a string encoding match both rules. This occurs if the two rules have at least one exact match bit that has a different encoding between the two rules. For example, the rules AA** and AB** are considered non-overlapping because no search string can match both rules.

Superset Rule: If two LPM rules overlap, the rule that has its highest (most significant) wildcard bit in a higher bit position than the other rule. For example, within the two rules AAA* and AA**, rule AA** is the superset rule because it has bits 0-7 wildcarded whereas rule AAA* has bits 0-3 wildcarded.

Subset Rule: If two LPM rules overlap, the rule that has its highest wildcard bit in a lower bit position than the other rule. For example, with the two rules AAA* and AA**, rule AAA* is the subset rule because it has bits 0-3 wildcarded whereas rule AA** has bits 0-7 wildcarded.

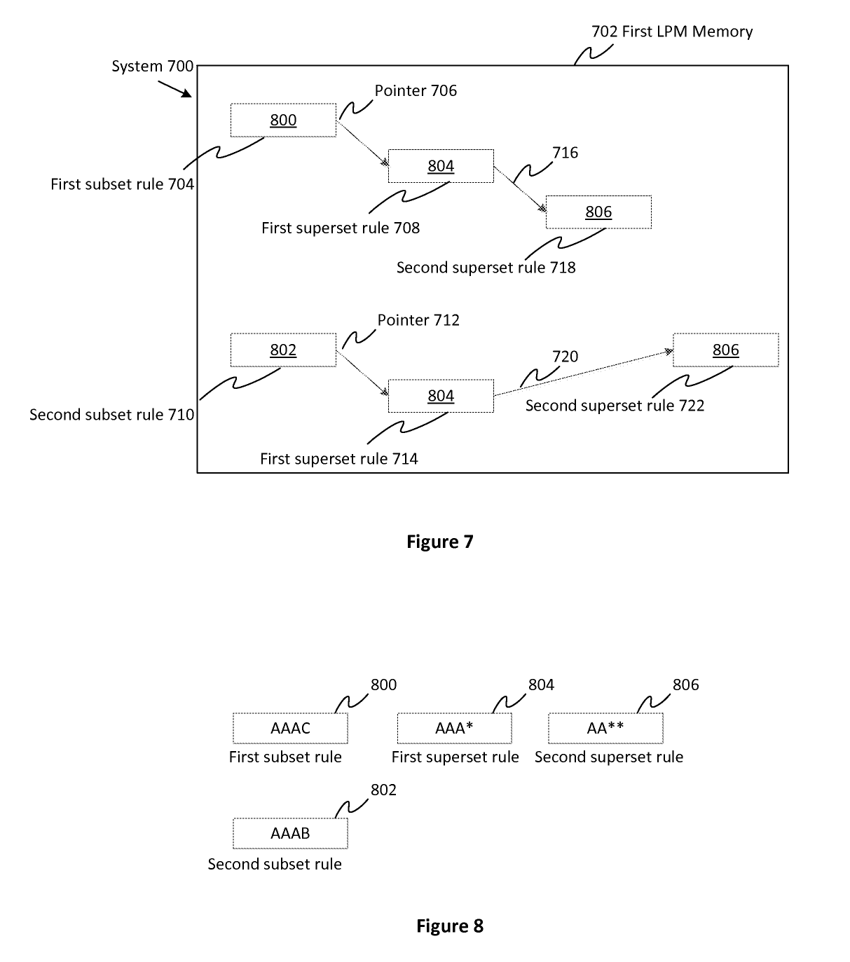

FIG. 7 is a schematic block diagram of a memory system organized for optimized multi-field longest prefix match (LPM) search accessing. The system 700 comprises a non-transitory first LPM rule memory 702, where an LPM rule includes explicitly defined bit values in at least the n most significant bit (MSB) positions in a field of digital information, where n is an integer greater than or equal to 0. The LPM memory may also be referred to herein as a table. The first LPM rule memory 702 comprises subset rules structured in a sorted search tree for a first field organized as a LPM rule. One example of a sorted search tree is an (Adelson-Velskii and Landis') AVL search tree. Other examples include a red black tree and a binary sorted tree, as would be understood by one with skill in the art. A subset rule is defined herein by a substring with at least one explicitly specified digital value that distinguishes the substring from every other rule substring in the first LPM memory. The first LPM rule memory 702 also comprises superset rules for the first field, where a superset rule is defined as a substring with a least one wildcard more than an associated subset rule, having a digital value overlapping the associated subset rule digital value. A wildcard is defined herein as having any digital value.

For example, a first subset rule may have a digital value overlapping a first superset rule, where the first subset rule and first superset rule have associated locations in the first LPM rule memory 702. A second subset rule may have a digital value overlapping the first superset rule, where the second subset rule and first superset rule have associated locations in the first LPM rule memory 702. In one aspect, the first superset rule has a digital value overlapping a second superset rule having at least one more wildcard than the first superset rule. Although the subset rules in this example are described as having two overlapping superset rules, it should be understood that any number of superset rules may overlap an associated subset. The system is not limited to any particular number of overlapping superset rules.

FIG. 8 is a diagram depicting an exemplary first subset rule, second subset rule, first superset rule, and second superset rule. Here, the first field is represented by four symbols of digital values. Each symbol of digital value may be a single binary digit (i.e. 1 or 0) or a summation of binary digitals. For example, each symbol or digital value may represent a hexadecimal number. The first subset rule 800 can be distinguished from the second subset rule 802, as the first (least significant) symbol of the two rules is different. The least significant symbol in the first subset rule is “C” and the least significant symbol of the second subset rule is “B”. The first superset rule 804 overlaps both the first and second subset rules, as the least significant symbol of the first superset rule (i.e. *) is a wildcard that may be either an “C” or a “B” (or any other possible digital value). Because the first two symbols of the second superset rule 806 are wildcards, the second superset rule overlaps the first subset rule 800, the second subset rule 802, and the first superset rule 804.

Returning to FIG. 7, in one aspect, the first subset rule has a first location 704 in the first LPM memory, represented as a first mask word with explicitly defined digital values and the position of wildcards in the first subset rule. The first location 704 also includes a pointer, schematically represented by reference designator 706, directed to a second location 708 in the first LPM memory containing the first superset rule. The first superset rule is represented as a second mask word with explicitly defined digital values and the position of wildcards in the first superset rule. The second subset rule 802 has a third location 710 in the first LPM memory, represented as a third mask word with explicitly defined digital values and the position of wildcards in the second subset rule with a pointer 712 directed to a fourth location 714 in the first LPM memory containing the first superset rule 804, represented as a fourth mask word with explicitly defined digital values and the position of wildcards in the first superset rule.

In one aspect, the first superset rule associated with the first subset is stored in the same location as the first superset rule associated with the second subset rule. Alternatively, as shown, the first superset rule associated with the second subset rule (i.e. a copy of the first superset rule) is stored in a different location than the first superset rule associated with the first subset rule. Likewise, second location 708 may include a pointer 716 directed to location 718 storing the second superset rule 806, and fourth location 714 may include a pointer 720 directed to location 722 with the second superset rule 806. Again, the second superset rule may be stored in a single location, or a shown, stored a copies in different locations.

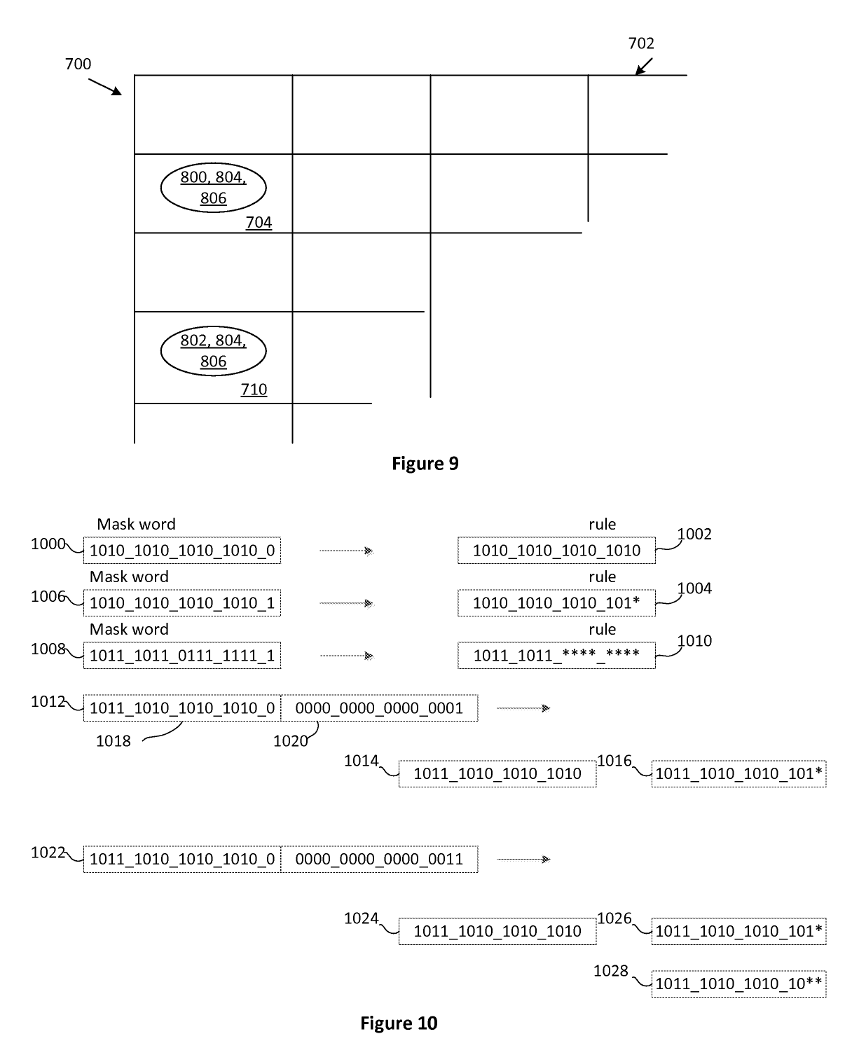

FIG. 9 is a schematic block diagram depicting a variation of the system of FIG. 7. In this aspect, the first subset rule 800 and first superset rule 804 are collocated in a first LPM memory location 704. The rules are represented as a first mask word with explicitly defined digital values and the position of wildcards in the first subset rule and the first superset rule. Likewise, the second subset rule 802 and first superset rule 804 are collocated in LPM memory location 710, and represented as a second mask word with explicitly defined digital values and the position of wildcards in the second subset rule and the first superset rule. Likewise, the second superset rule 802 can be collocated in locations 704 and 710.

FIG. 10 is a depiction of exemplary mask words. Mask word 1000 is associated with rule 1002. In this example, a 4-symbol rule is represented by a 5-symbol mask word. Here, the symbol indicating the mask is only a single bit, whereas the other symbols are 4 bits per symbol. The value AAAA is a hexadecimal representation. Each “A” is actually 4 bits, representing in binary as 1010. Thus, if the least significant two symbols are 01, signifying that 1 bit is masked, then the value is 1010_1010_1010_101*. In this first example, all the symbols in the rule are explicitly defined (they are all “A”s). In this representation, if the least significant symbol in the mask word 1000 is “0”, then no symbols (digital values) are masked.

The least significant symbol of rule 1004 is a wildcard. The least significant symbol of mask word 1006 is a “1” signifying that at least one symbol is masked. The count of the actual number of symbols to be masked is a sum that begins at the symbol with the “0” value in the mask word (the position of the most significant wildcard in rule 1004), and adds the digital value for each position between the “0” value position and the least significant symbol. In this example, the sum is (0+1=1), so only one symbol (the least significant symbol) is masked. Mask word 1008 represents a rule 1010 with two wildcards.

Mask word 1012 is a mask word suitable for use when a superset rule 1016 is collocated with a subset rule 1014. The subset rule 1014 has four explicitly defined symbols (AAAA), while the superset rule has three explicitly defined symbols and a wildcard (AAA*). Both rules are represented in the mask word 1012. The four most significant symbols of the mask word in the first field 1018 represent all the explicitly defined symbols in the subset rule 1014, in this case four, while the position of “1”s in the second field 1020 in the mask word represents the position of wildcard bits in the superset rule(s).

Mask word 1022 is associated with a subset rule 1024, a first superset rule 1026, and a second superset rule 1028. The second superset rule 1028 overlaps both the superset rule 1024 and the first superset rule 1026, while the first superset rule just overlaps the subset rule. The first field in the mask word 1022 represents all the explicitly defined digital values in the subset rule 1024. However, the first field of mask word 1022 also gives an indication of how many bits are masked in the subset rule 1024. In this example, all the bits in subset rule 1024 are explicitly defined. In the second field of the mask word 1022, the “1” in the least significant symbol position indicates a superset rule (e.g., superset rule 1026) with one wildcard, while the “1”s in the second least significant symbol position indicates the existence of a superset with two wildcards. Note: if superset rule 1026 did not exist, the second field of mask word 1022 would be 0000_0000_0000_0010.

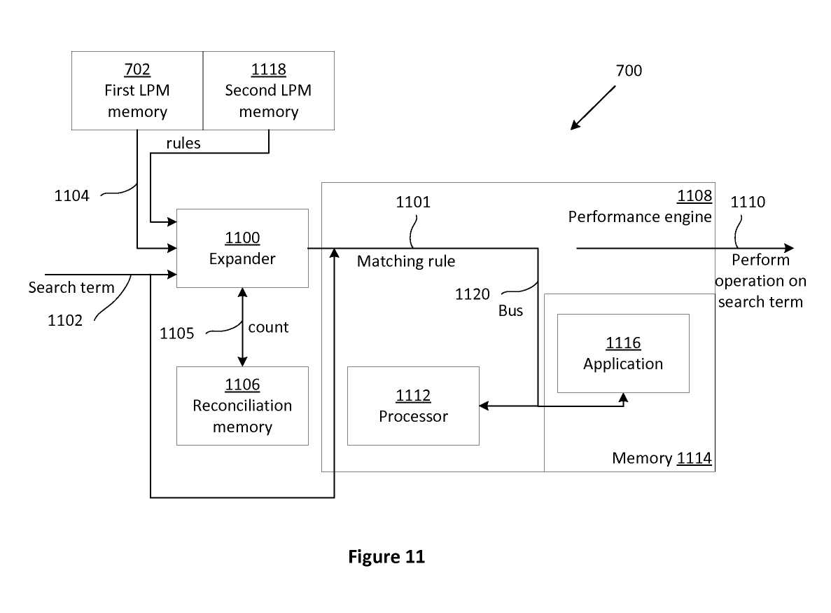

FIG. 11 is a schematic block diagram of the systems of FIGS. 7 and 9 with additional components. An expander 1100 has an input on line 1102 to accept a search term with a first field and an input on line 1104 to accept the first subset rule. The expander compares the search term to the first subset rule, and acknowledges a matching rule on line 1101 when all bits in the search term match the explicitly defined bits in the first subset rule. When all the bits in the search term fail to match the explicitly defined bits in the first subset rule, the expander 1100 counts the number of explicitly matching bits to create a current count and compares the current count to a previously stored count received on line 1105. If the current count is greater than the previously stored count, the expander 1100 replaces the previously stored count with the current count and stores the first subset in a reconciliation memory 1106. Then, the expander 1100 accepts the next subset rule in the first LPM rule memory 702 for comparison to the search term.

In one aspect consistent with the system of FIG. 7, the expander 1100, subsequent to comparing all the subset rules in the first LPM memory to the search term and not finding a match, accesses the subset rule in the reconciliation memory 1106, and reads a pointer directed to an associated superset rule. Alternatively, the associated superset rule may be loaded into the reconciliation memory at the same time that the subset memory is loaded. The expander 1100 masks the search term with wildcards from the associated superset rule, and if the unmasked bits in the search term match the associated superset rule, acknowledges the associated superset rule as the matching rule on line 1101. If the unmasked bits in the search term do not match the associated superset rule, and a pointer exists with directions to another superset rule, then the unmasked bits in the search term are compared to this second superset rule to determine a possible match.

Alternatively, in accordance with the system of FIG. 9, the expander, subsequent to comparing all the subset rules in the first LPM memory to the search term and not finding a match, accesses the subset rule in the reconciliation memory 1106, and masks the search term with wildcards from a collocated superset rule. If the unmasked bits in the search term match the collocated superset rule, the expander 1100 acknowledges the collocated superset rule as the matching rule. In the case of more than one collocated superset rule, the expander acknowledges the superset rule with the greatest number of explicitly matching digital values as the matching rule. As another alternative, the subset and superset rules at a particular LPM memory are compared at the same time, and if none of the subset rules match, then the superset rule with the most bits matching is selected as the matching rule.

In one aspect, a performance engine 1108 has an input on line 1101 to accept an instruction associated with the matching rule, and an output on line 1110 to perform an operation on the search term, responsive to the instructions. The instructions may be collocated with the rules as data in memory 702, or the rules may include pointers to a different memory (not shown) where the instructions are stored. As shown, the performance engine 1108 may be comprised of a processor 1112, a local non-transitory memory 1114, and a software application 1116 stored as a sequence of processor instructions in memory 1114 enabled to perform operations on the search term. Alternatively, but not shown, the performance engine may be enabled by combinational logic. The processor 1112 may be connected to memory 1114 via an interconnect bus 1120. The processor 1112 may include a single microprocessor, or may contain a plurality of microprocessors for configuring the computer device as a multi-processor system. Further, each processor may be comprised of a single core or a plurality of cores. Memory 702 and 1114 may include a main memory, a read only memory, and mass storage devices such as various disk drives, tape drives, etc. The main memory typically includes dynamic random access memory (DRAM) and high-speed cache memory. The memories may also comprise a mass storage with one or more magnetic disk or tape drives or optical disk drives, for storing data and instructions for use by processor. At least one mass storage system in the form of a disk drive or tape drive may stores the operating system and application software. The mass storage may also include one or more drives for various portable media, such as a floppy disk, a compact disc read only memory (CD-ROM), or an integrated circuit non-volatile memory adapter (i.e. PC-MCIA adapter) to input and output data and code. In one aspect, the expander and performance engine are both enabled by the processor in concert with one or more related software applications stored in memory.

In another aspect, the system 700 comprises a non-transitory second LPM rule memory 1118, which comprises subset rules structured in a sorted search tree for a search term second field organized as a LPM rule, as well as superset rules for the second field. In the interest of brevity, details of the second LPM rule memory are not explained or shown in detail, but it should be understood that it is organized in a manner equivalent to the first LPM rule memory 702. As is consistent with a hierarchical tree, the result from the first search points to the start of the second search, so the result from the second search is the only result passed forward by the performance engine 1108. Thus, the output on line 1110 represents an operation on the search term, responsive to the instructions that result from second search in the second LPM memory. Although only two LPM memories have been described, it should be understood that a separate LPM memory may exist for each field in the search term.

In one aspect, the system of FIG. 11 may be enabled as a packet processing system with the first LPM memory 702 organized with subset and superset rules as described above. Here, the expander 1100 accepts a search term from a packet, for example, a packet overhead field. As described above, the expander 1100 initially compares the search term to the subset rules, and if all the bits in the search term fail to match the explicitly defined bits in the subset rules, it compares the search term to the superset rules. The performance engine 1108 accepts the packet and the matching rule, and modifies the packet in response to instructions associated with the matching rule.

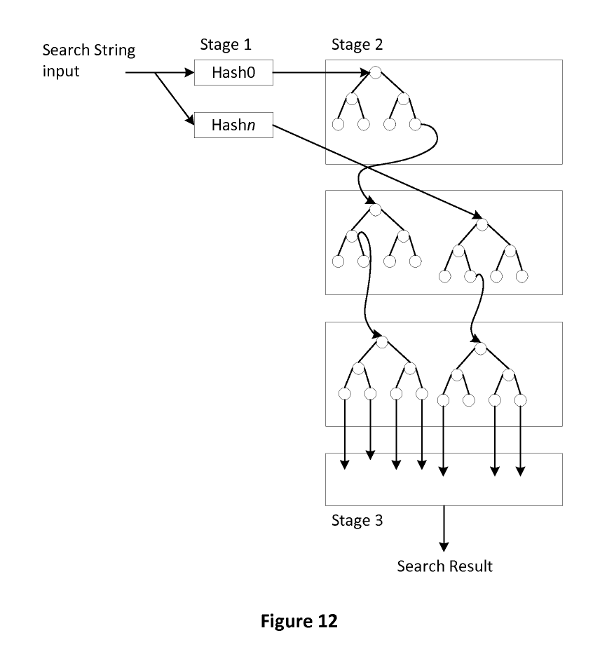

FIG. 12 is a diagram depicting the search process divided into three stages. The system disclosed herein uses a hierarchical trie search and implements several innovations that improve performance and reduce RAM requirements. The method divides the search process into three stages. Stage 1 partitions the rules into multiple tables that can be searched in parallel. Stage 2 divides the string into smaller substrings and performs a hierarchical search within each table to narrow down the matching rules to a small predetermined number of rules. For substrings that are configured as having either exact match or LPM patterns, an AVL tree may be used. For substrings that are configured as access control list (random wildcard), multi-level hashing followed by variable stride linear search may be used. Each substring separates the rules into sets of overlapping and non-overlapping rules such that the subsequent substring only searches the rules that have a potential of matching the search string. Stage 3 consolidates the results from all parallel searches and picks the best matching rule from all matching rules.

Stage 1: Partition Rules into Multiple Tables

In Stage 1 a separate linearly searched random access memory (RAM) may be implemented called the Bad Rules Table. The Bad Rules Table is used to store rules that have the largest amount of overlap and cause the highest amount of rule expansion. The advantage of keeping these rules in a separate database is the rules that cause the most expansion can still be searched but are not added to the table, and thus the worst expansion is avoided altogether. For example, a rule such as ****-****_****_**** overlaps with all other rules in the table and thus can cause excessive rule expansion. By placing this rule into a separate RAM, rule expansion due to that rule is avoided entirely. The Bad Rules Table RAM can also be used as temporary storage when rules are being added or deleted from table. This also makes add and delete operations atomic in case the tables need to be updated in multiple places when a rule is added or deleted. The linear search time of the Bad Rules Table is bounded so that it is equal to or less than the search time through the main database, thereby guaranteeing that the Bad Rules Table does not cause any performance degradation.

In Stage 1 multiple parallel tables are implemented with different starting substrings for hierarchical search. The advantage is rules can be divided into multiple tables based on their interaction with each other. By dividing rules into multiple tables, the expansion created by rules that overlap can be reduced. In hierarchical search, rules that have wildcards in leading substrings result in the most expansion or require the most backtracking. By separating rules into tables and reordering the search substrings, those with the least number of wildcards are ordered first. Often rule patterns are such that they cause maximum expansion or bloating in one particular substring and other substrings RAMs are sparsely populated. By separating the rules into multiple tables, the peak RAM usage is smoothed out so that all the RAMs are more evenly utilized. This reduces the overall RAM allocation regardless of the rule patterns.

In one implementation of the system, a rule is added to the first table if its first substring has no wildcards, is added to the second table if the first substring has wildcards but the first substring of the second tuple does not have wildcards, is added to the third table if the first substrings of the first and second tuple have wildcards but the first substring of the third tuple does not have wildcards, and so on. If the first substrings of all tuples have a wildcard then the rule is added to the first table. In another implementation of the system, a rule is added to the table which has the substring with the least amount of wildcards. If two or more substrings have the same amount of wildcards, then the rule is added to the table that has the least number of rules. If two or more tables have the same least number of rules, then the rule is added to the earliest table.

For each starting substring, a hash table is created that indicates whether any rules that match that hash value are included in that table. If a particular search string's hash indicates that a matching rule may exist in a table, then that table is searched. If a particular search string's hash does not indicate that a matching rule may exist in a table, then that table is not searched. Simple hash functions are used so that rules that have wildcards do not get copied to different hash locations.

Stage 2: Divide String into Substrings and Perform Hierarchical Search

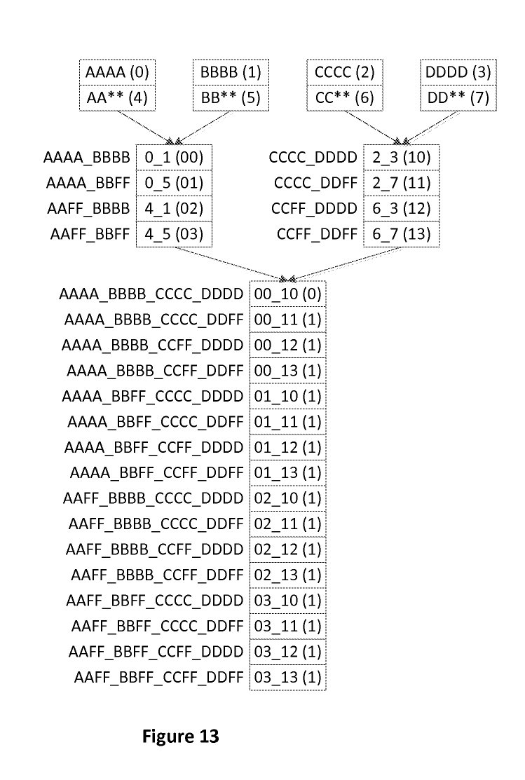

FIG. 13 is a diagram depicting the results of a cross product search. This system uses the hierarchical trie search approach instead of cross product tries. Cross product tries result in higher rule expansion. With cross product tries, it is difficult to update rules atomically. Hierarchical tries do not exhibit these problems. Many real world implementations make it difficult to find overlapping rules and complicate the add delete process. For example, if a rule table contains the rules AAAA_BBBB_CCCC_DDDD and AA** BB**_CC** DD**. In the cross product trie example, the first substring table contains the substrings AAAA and AA**, the second substring table contains the substrings BBBB and BB**, the third substring table contains the rules CCCC and CC** and the fourth substring table contains the rules DDDD and DD**. Since each substring search is done in parallel and the results are then concatenated, these two rules result in the cross products shown. As can be seen from the example, two simple overlapping rules result in 16 separate rules being created using the cross product trie approach.

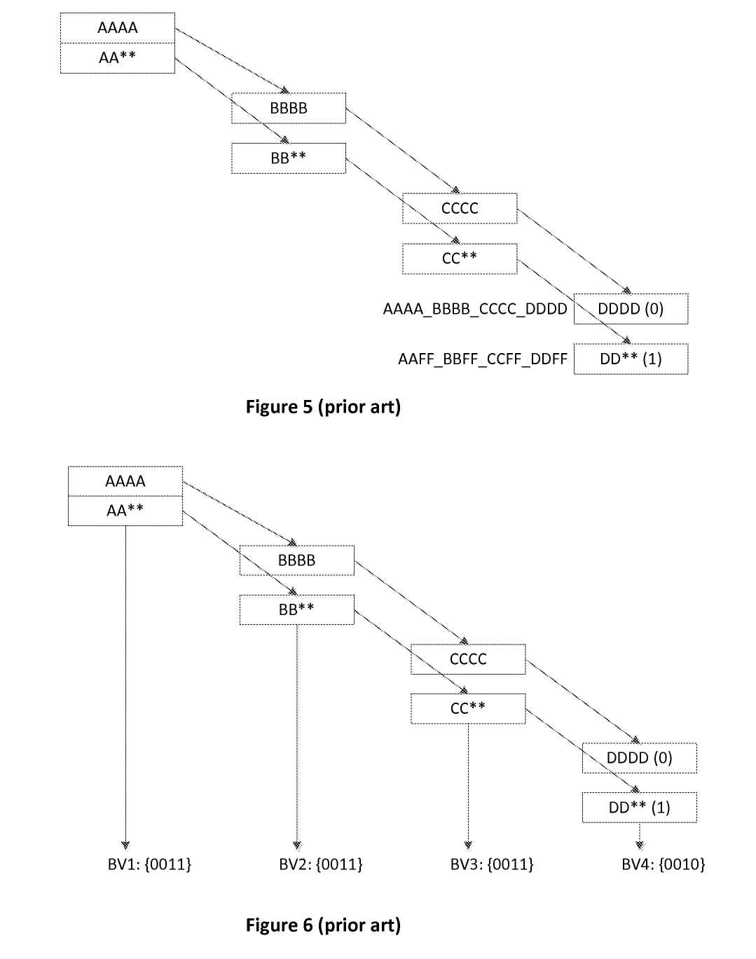

The system disclosed herein implements several innovations on top of the hierarchical trie to further improve memory utilization, search performance, and table update performance. The hierarchical trie search divides the string (search term) into several smaller substrings. Conventional hierarchical tries require backtracking when rules overlap in a leading substring. Returning briefly to FIG. 5, in this example, if the search string is AAAA_BBBB_CCCC_DDFF, and if the first rule matches the first three substrings, it is only when the last substring table is read that it is realized that the search string does not match the rule. At this point, the search process must backtrack to the first substring and traverse the AA** tree to find that rule AA**_BB**_CC**_DD**, which does match the search string AAAA_BBBB_CCCC_DDDD.

Dividing Substrings into LPM or ACL (Random Wildcard) Configurations

Each substring within the search string can be configured as either having LPM masks or random wildcard masks. This configuration can be determined up front based on a particular deployment of this system. It should be noted that LPM is a subset of random wildcarded rules can be processed using the ACL configuration as well. However, a different approach is used for LPM configuration because they are commonly used and a more efficient approach can be used for these rules. The system disclosed herein reorders all substrings such that substrings with LPM configuration are grouped together and substrings with ACL configuration are grouped together. A preprogrammed configuration bit indicates whether the LPM substrings should be processed first or the ACL substrings should be processed first. The determination of which substring group should be processed first can be based on many different parameters such as the number of substrings of each group or the actual rule pattern in a table. In one realization of the design, the LPM substrings are always processed first and the ACL substrings are processed last. This is done because it is easier to order rules that have LPM masks than those that have random masks. Once the substrings have been reordered, the system uses two different approaches to address the search problem. LPM configured substrings are processed by separating the rules into groups of non-overlapping vs overlapping rules, and ACL configured substrings are processed using a multi-level hashing and variable stride linear search approach.

### Processing LPM Configured Substrings

If a table contains the rules AAAA_BBBB_CCCC_DDDD and AA**_BB**_CC**_DD**, and the search string (search term) is AAAA_BBBB_CCCC_DDFF, then it can be seen that the search process would match AAAA in the first substring and follow its pointer to its subtree, match BBBB in the second substring and follow its pointer to its subtree, match CCCC in the third substring and follow its pointer to its subtree. There, the search process would determine that the search substring DDFF does not match DDDD and hence rule 0 does not match the search string. The search process must now backtrack to the first substring and recognize that AA** also matches the search substring AAAA. Therefore, it must follow the pointer to the subtree from AA** and determine that DDFF matches DD** and hence rule 1 matches the search string. Furthermore, if the rule table had assigned the rule AA**_BB**_CC**_DD** a higher priority than rule AAAA_BBBB_CCCC_DDDD, then the search process has to either reverse the process and search the higher priority rule AA**_BB**_CC**_DD** first, or the process must always traverse all matching rules and then select the highest priority rule out of all matching rules.

One way of avoiding backtracking in hierarchical trie searches is to use the bit map vectoring technique described in the Background Section above. This technique works well provided the number of rules are small, but does not scale well to larger tables since the bit vector becomes too large to handle all possible cases. If a particular rule table consists of n rules of size s bits, and the rule is divided into m substrings, then each rule substring needs to store an n-bit vector since that particular encoding could belong to all rules. This results in a requirement of (2^{m}×n)×(s/m) bits. For example, if a table has 4K rules that are 512 bits, and each substring is 16 bits, then the amount of storage required for the bit map vectoring technique is 2¹⁶×4K×32=2³³=8 M bits of storage.

Prior art methods have attempted to reduce the overhead associated with bit map vectoring, but doing so complicates rule addition and limits the number of rules that can have a particular substring encoding. Thus, the bit map vectoring technique has excessive overhead and only small tables are able to utilize this technique since it does not scale well to larger tables.

### Replicating Superset Overlapping Rules in Subtrees

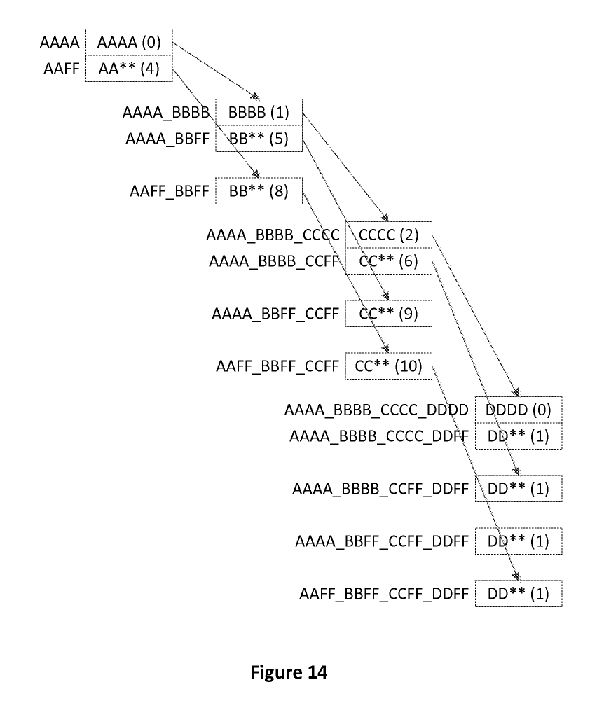

FIG. 14 depicts an exemplary tree structure. The system disclosed herein uses a different technique that avoids backtracking in the hierarchical trie and does not need bit map vectoring. The technique used is to copy an overlapping superset rule into all its overlapping subset rule trees. Thus, a following substring tree is constructed which includes all overlapping rules that match the previous substring. For the above example, the tree following substring AAAA will contain BBBB as well as BB** because substring AA** is a superset overlapping rule of AAAA. Similarly, since BBBB and BB** overlap, the tree pointed to by BBBB contains both CCCC and CC**, and since CCCC and CC** overlap, the tree pointed to by CCCC contains both DDDD and DD**. The resulting tree structure is illustrated in the figure. While this appears to create a lot more rules than the simple hierarchical trie with backtracking approach or the hierarchical trie with bit map vectoring approach, the system disclosed herein minimizes this overhead by using two additional techniques.

Minimizing Overhead Associated with Replicating Superset Overlapping Rules

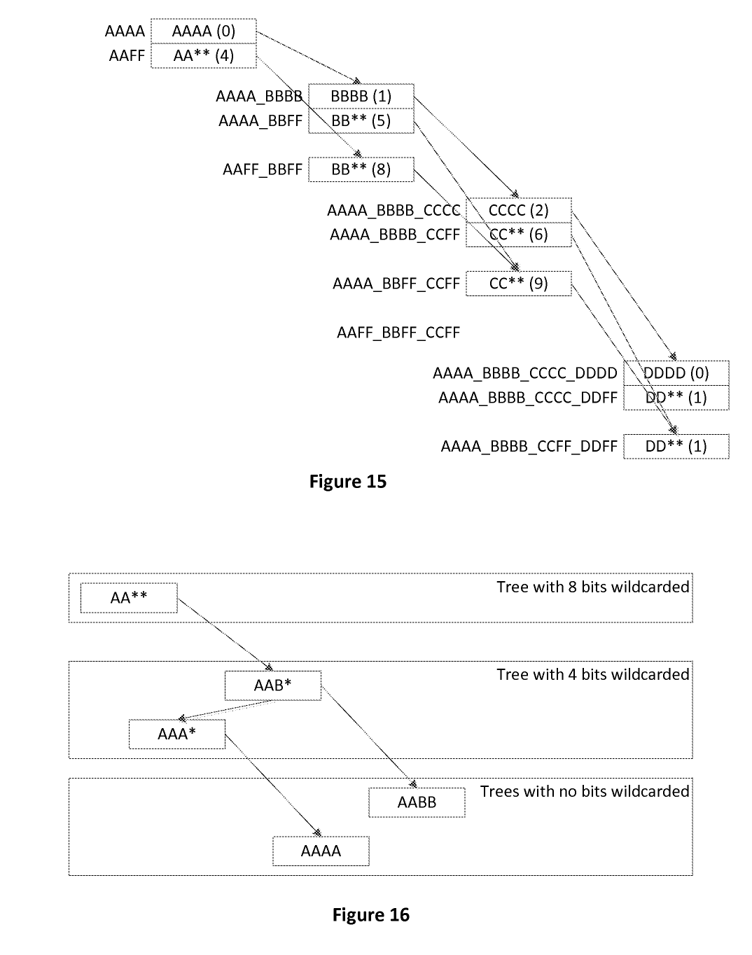

FIG. 15 is a drawing depicting an exemplary tree with reduced rule expansion. The first technique is to recognize that if a subsequent substring rule has an encoding that is only present in the superset overlapping rule, then that tree can be combined with other trees. In the example rule table with the rules AAAA_BBBB_CCCC_DDDD and AA**_BB**_CC**_DD**, it can be observed that in the second substring the tree for rule AAAA_BB** is the same as the tree for rule AA**_BB**. Therefore these two trees can be combined. Similarly, in the third substring the tree for rule AAAA_BBBB_CC** is the same as the tree for AAAA_BB** and AA**_BB**. Therefore, the trees can be combined as well, resulting in even lower rule expansion.

The second technique used to minimize the overhead associated with replicating superset overlapping rules is to separate all rules into groups of non-overlapping subset rules and overlapping rules. The non-overlapping subset group contains all the rules that do not overlap each other and are the subset rule of a group of overlapping rule. Non-overlapping rules are defined as those rules that are mutually exclusive of each other such that a given search string can only match one rule out of that group. A subset rule is defined as the rule that has the most exact match bits amongst a group of overlapping LPM rules.

For example, if a table contains the rules AAAA, AABB, and AA**, then the non-overlapping subset group will contain the rules AAAA and AABB, and the overlapping group will contain the rule AA**. If a table contains the rules AAAA, AAB*, and AA**, then the non-overlapping subset group will contain the rules AAAA and AAB*, and the overlapping group will contain the rule AA**.

FIG. 16 depicts a table with overlapping rule pointers. When a table contains rules with varying numbers of wildcards and rules that overlap each other, a mechanism of efficiently searching through the rules is necessary. The rules must be ordered in some fashion so that all matching rules can be found. This can be done in two ways—one is to search through the superset non-overlapping rules first, and then to search through to the subset rules. For example, if a table contains the rules AAAA, AABB, AAA*, AAB*, AA**, and BBBB, then the rules could be ordered such that rules AA** and BBBB are in one table. A pointer from AA** can then point to its next overlapping rules, AAA* and AAB*. A pointer from AAA* can then point to AAAA, and a pointer from AAB* can then point to AABB, as shown.

A drawback of this approach is that the worst case number of accesses required to search through this table is the size of the substring plus 1. If the substring size is 16 bits, then the worst case number of accesses required can be calculated as:

$$1 ( all bits masked ) + 1 ( rules with one bit unmasked ) + 1 ( rules with two bits unmasked ) + 1 ( rules with three bits unmasked ) + 1 ( rules with four bits unmasked ) + 1 ( rules with five bits unmasked ) … + 1 ( rules with all bits unmasked ) = 17 accesses .$$

For example, a table that contains the rules 16′b****_****_****_****, 15′b1***_****_****_****, 14′b11**_****_****_****, and so on till 16′b1111_1111_1111_1111, requires 17 accesses to read all the overlapping rules. This can significantly affect search throughput and latency.

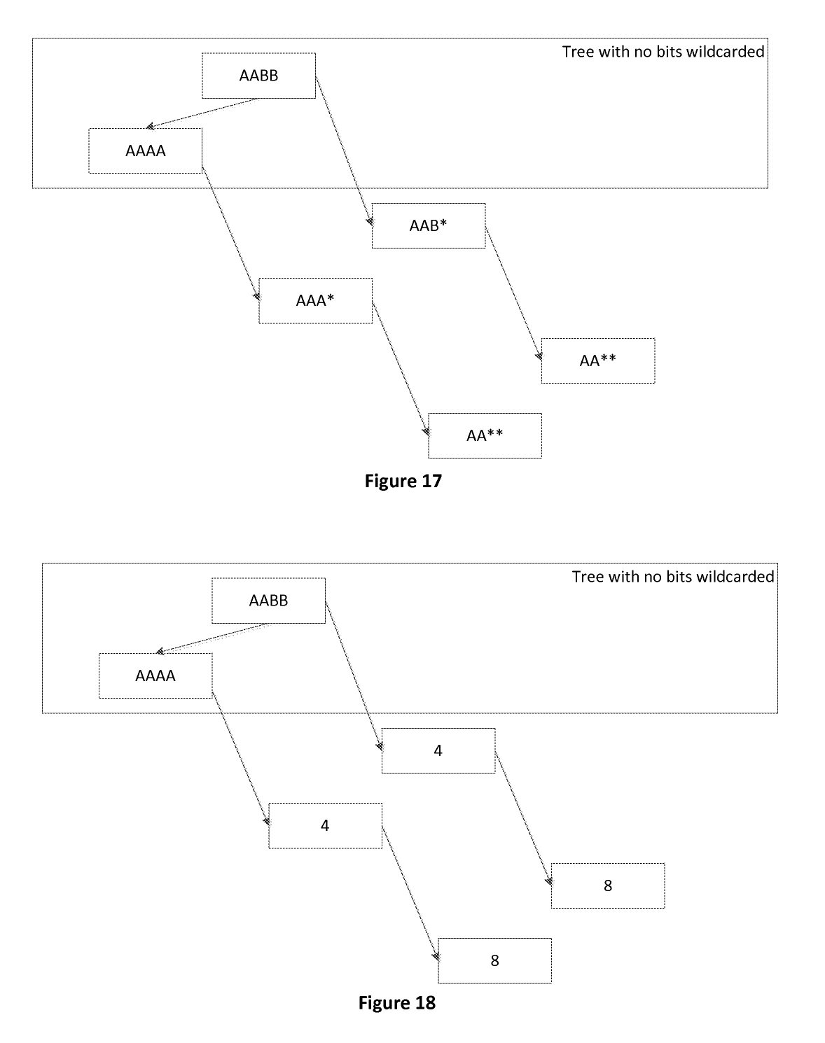

FIG. 17 is a drawing depicting the table of FIG. 16 where the subset rules are searched before superset rules. In order to avoid the above-mentioned drawback, the system disclosed herein first searches through the subset overlapping rules, and then from each subset overlapping rule provides a pointer to all the superset rules that overlap with that particular rule. For the same table described above in FIG. 16 that contains the rules AAAA, AABB, AAA*, AAB*, and AA**, the rules are ordered as shown in FIG. 17.

With this arrangement of rules, any subset rule that is in the first level tree can have only one superset overlapping rule with a given number of bits masked. For example, the rule AAAA can only have one superset overlapping rule with four bits masked—AAA*. Thus, the worst case number of accesses required to access all rules in a table of n non-overlapping rules can be calculated as:

Log₂(n)(to search all non-overlapping rules)+1(overlapping rules with masked bits)

FIG. 18 is a diagram depicting a table with a compressed representation of superset rules. Thus, the system disclosed herein reduces the number of accesses required to search through rules that overlap each other. An additional optimization recognizes that per subset rule, there is only one superset overlapping rule with a certain number of bits masked. In this case, there is no need to keep the explicit value of every superset overlapping rule since the unmasked bit value is already known from the subset rule. For example, in a table that contains the rules AAAA, AABB, AAA*, AAB*, and AA**, if the subset rule AAAA is found, then the superset overlapping rule AAA* can be identified by simply keeping track that the four LSBs are masked (assuming each symbol is four bits), and the superset overlapping rule AA** can be identified by simply keeping track that the eight LSBs are masked. Thus, a compressed representation can be created that identifies all superset overlapping rules for a particular subset rule.

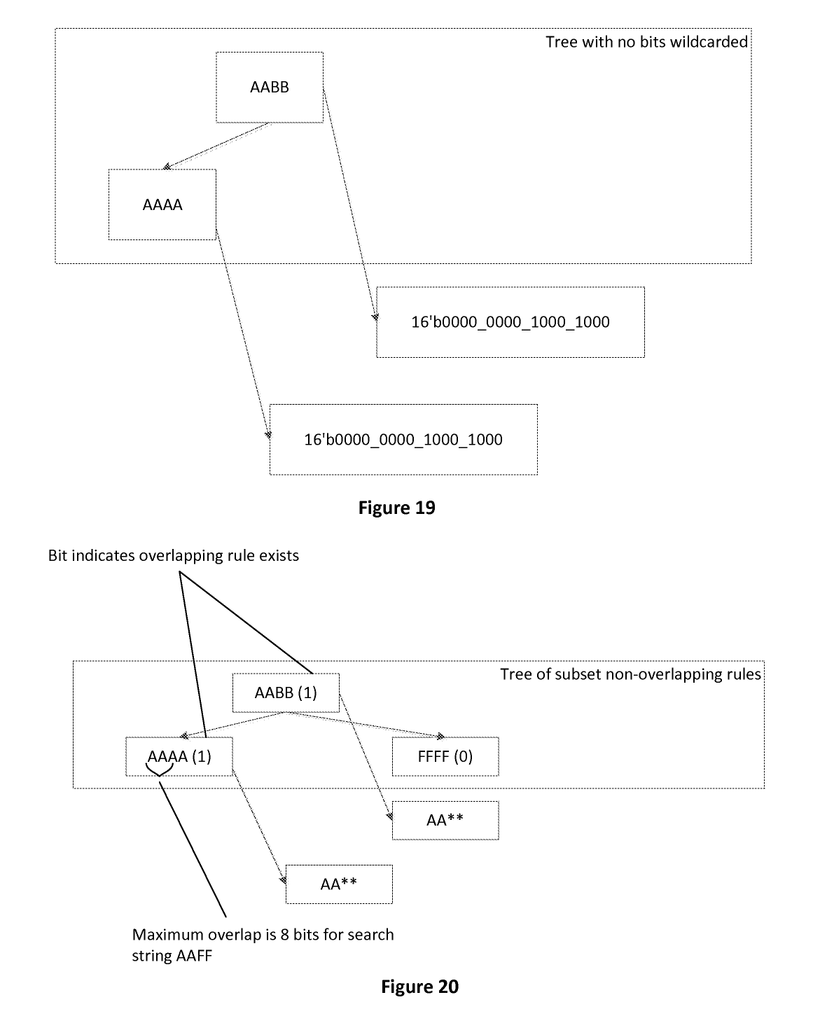

FIG. 19 is a diagram depicting an additional compression technique. Yet another optimization that can be made is to realize that if there are a lot of superset overlapping rules for a particular subset rule, then a bit wise mask instead of an explicit encoded mask value is sufficient to identify all overlapping rules.

FIG. 20 is a depiction of a table where the subset rules include extra information to indicate the existence of an overlapping superset rule. One potential problem when searching through the subset overlapping rules is that a string that matches a superset overlapping rule, but does not match any subset overlapping rule, may not find its match. For example, if a table contains the rules AAAA, AABB, and AA**, then the rule AA** will not be included in the first table of non-overlapping subset rules. In this case, a search for string AAFF will not find a matching rule in the first table. To address this issue, the system may add a bit to each subset rule that indicates whether it has an overlapping superset rule. The search process also determines the subset rule that has the most significant bits that match the search string. For example, if the table contains the rules AAAA, AABB, and AA**, then both rules AAAA and AABB include an indication that they have a superset overlapping rule. During the search process, the rule AAFF is compared to both rules, and since the most significant 9 bits match between AAAA and AAFF, and also between AABB and AAFF, and both rules indicate that they have superset overlapping rules, the search process follows the pointer from one of the rules to find its overlapping superset rules, and thus successfully finds the matching rule.

If multiple subset rules have the same number of matching bits, then any one of the rules can be selected to find the overlapping superset rule. The rule that has the most number of matching most significant bits is selected because this is the rule that will contain all possible superset overlapping rules. For example, consider a table where the existing rules are AAAA, ABBB, AAA*, and A***. In this case, the non-overlapping subset rules are AAAA and ABBB, with a pointer from AAAA to AAA* and A***, and a pointer from ABBB to A***. Note that in this rule set, AAA* overlaps AAAA but not ABBB. If the search string is AAFF, then the rule that has the most matching MSBs is AAAA>AAA*>A***, since AAAA has 9 matching MSBs and ABBB only has 7 matching MSBs. If the string is AFFF, then both AAAA and ABBB have 5 matching MSBs so it does not matter whether ABBB or AAAA is selected for traversal.

### Traversing Multiple Levels of the AVL Tree in a Single Cycle

When a table contains n rules (where n is a power of 2) that are sorted in a binary fashion, it takes a worst case log₂(n)+1 searches for a rule. For example, for a table that contains 64 rules, it will take, worst case, 7 cycles to search for a rule. This number can be reduced if multiple levels of the tree are mapped into a single access. For example, if two levels of the tree are compared in each cycle, then the worst case search time is reduced to half, and if three levels of the three are compared in each cycle, then the worst case search time is reduced by a third.

When the rule strings in a table are long, the comparators needed to compare the rule to the search string can become difficult to design and operate at a fast clock frequency. The amount of logic needed to compare a 64 bit value is exponentially more complicated than the amount of logic needed to compare a 16 bit value. Rather than comparing one 64 bit rule per cycle in a sorted tree, the system disclosed herein divides the rule into substrings and performs multiple searches of the tree in a single cycle. This technique results in an optimized solution that is easier to operate at a faster frequency and results in lower search latency since multiple levels of the tree are traversed in a single cycle.

### AVL Tree Leveling

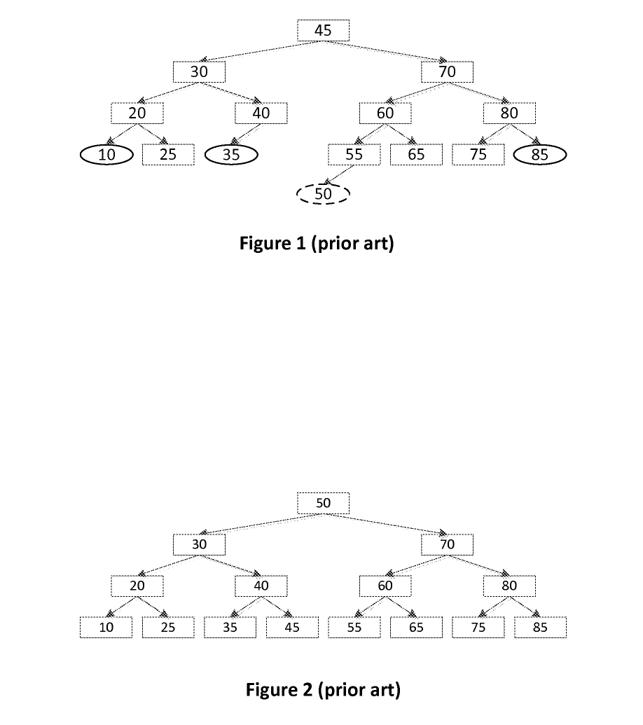

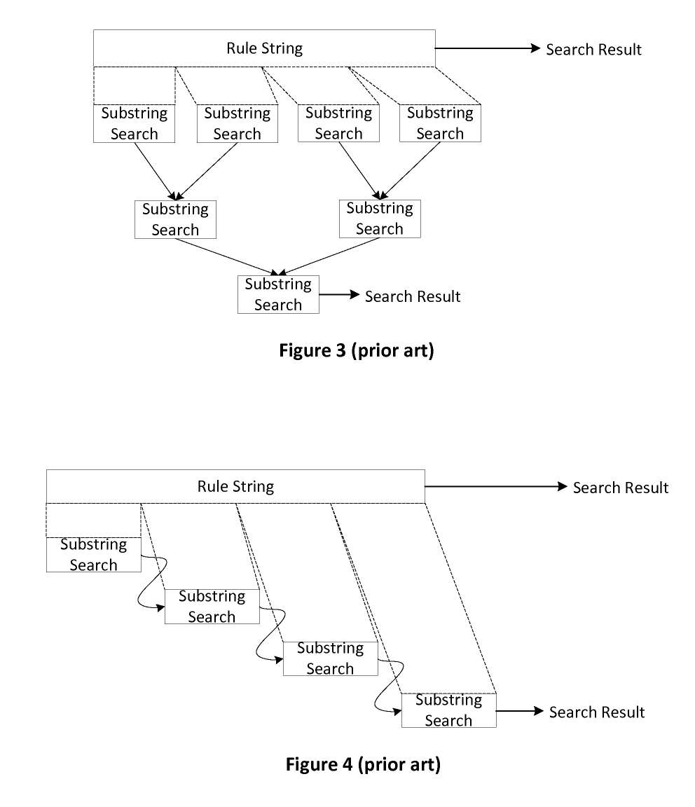

One drawback of the AVL tree algorithm is that it can exceed the tree depth of a sorted binary tree. This can cause a performance problem since each traversal of a tree level represents additional accesses that may be required. Returning briefly to FIG. 1, the tree in the figure could be rearranged to be a perfectly balanced binary tree that can store 15 rules with a tree depth of 4. As shown, the tree meets the AVL tree balancing requirement but requires a tree depth of 5. In this example, the rules 10, 35 and 85 could be removed and it would still meet the requirements of being a balanced AVL tree.

The system disclosed herein may implement an enhanced AVL tree leveling algorithm that keeps the AVL tree structure, but reduces the tree depth to that of a balanced binary tree. The tree leveling approach exploits the fact that in an AVL tree new rules are always added to the leaf of a tree. Instead of maintaining the AVL tree balance information at each rule in the tree, the tree leveling approach keeps track of whether there is any space available in its left subtree and in its right subtree. If a rule is to be added to a subtree that has no space available, but the other side has space available, then the system moves the root rule to the side that has space available, and moves one leaf rule from the side that is full to the root rule position, thereby creating space for the new rule. The system then updates the subtree full status at each rule. By following this procedure, the system guarantees that the tree depth is increased only when both subtrees are full, and this can only occur when the tree is perfectly balanced. The drawback of this algorithm is that it may result in more processing than the baseline AVL algorithm.

AVL Tree Leveling when Rules are Deleted

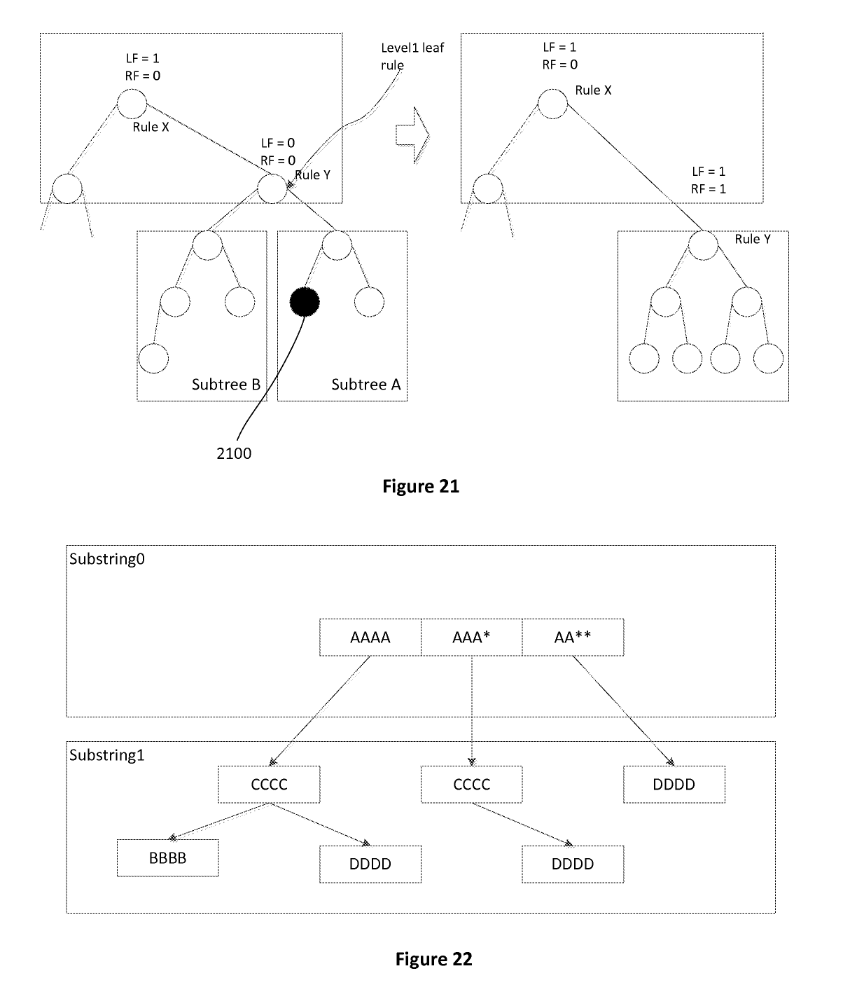

FIG. 21 is a diagram depicting the releveling of an AVL tree. In an AVL tree, rules are always added at a leaf position. However, rules can be deleted from any position. In order to determine whether a tree needs releveling when a rule is deleted, the system disclosed herein may make the following enhancements. When a rule is deleted, it is replaced by either the leftmost rule in the deleted rule's right subtree, or the rightmost rule in the deleted rule's left subtree. If one of the subtrees indicates that it is full, then that is the side from which the replacement rule is selected. If both sides indicate full, or both sides indicate not full, then it does not matter which subtree is selected. When the leaf rule is selected for replacement, the system counts the number of rules left in that leaf node. If the rule tree extends into an additional level, then the subtree full/not full status of both subtrees of the parent rule is examined. If one of the subtrees indicates full, then the system knows the number of rules that are present in that subtree, and it does not need to examine that subtree to determine the total number of child rules that exist from that parent rule in both its subtree. If the other subtree also indicates it is not full, then the system reads that subtree to determine the total number of child rules that exist from that parent rule. If this number indicates the parent rule can be pushed down one level in the AVL tree, then the algorithm pushes the rule down. It then recursively examines all nodes towards the root node and determines if any of the rules can be pushed down.

In this example, rule 2100 is deleted resulting in two rules left in subtree A. Note that before the rule is deleted, there are three rules in Subtree A and four rules in Subtree B, and thus 7 rules that are children of Rule Y. The system can determine that if Rule Y is included, the 8 rules will take 4 levels in a binary sorted tree, and thus Rule Y cannot be pushed down a level. However, once rule 2100 is deleted, the system detects that both subtrees are not full and the total number of rules below Rule Y (including itself) is 7, and therefore these rules can be accommodated in a 3 level tree. Thus, Rule Y can be pushed down one level once rule 2100 is removed. Once Rule Y is pushed down one level, the system knows exactly how many rules are in the right subtree for Rule X. Additionally, since Rule X's left subtree is full, it also knows the number of rules that are in its left subtree. If this total number of rules (7+15=22) requires 5 levels of a binary tree, then Rule X cannot be pushed down. In the above example if Rule X had an indication that its left subtree was also not full, then the system would have to examine its left tree and count the total number of rules that are in its tree, and then determine whether Rule X can be pushed down or not.

### Compact Representation of Mask Bits in LPM Rules

When a rule can have any number of bits masked, the typical way of storing this information is to use two bits per one bit of rule. One of the two bits indicates whether that bit is masked or not, and the other bit indicates whether the bit is a 0 or a 1 in case it is not masked. In an LPM rule, since bits are masked from a most significant bit all the way to the least significant bit of that field, simply keeping track of the most significant bit that is masked is sufficient. For example, a substring of 16 bits can have its mask bits indicated by 5 bits, with each encoding indicating the number of bits starting from the LSB that are masked. So a value of 0 means no bits are masked, a value of 1 means the 1 LSB is masked, an value of 2 means the 2 LSBs are masked, and so on. Thus, an LPM rule of n bits can be described by n+logₙ(2)+1 bits. However, the system disclosed herein further compresses this representation by recognizing that whenever a bit is masked, the bit used to indicate its actual value is not being used. For example, if a substring has 16 bits and the mask field indicates that 1 bit is masked, then the LSB bit does not contain any useful information since it is masked. Therefore, this bit can be used to store additional information. The system disclosed herein thus uses only 1 additional bit to indicate which bit is the last bit masked in the following fashion.

If the Mask bit is 0, it means the rule is an exact match rule

If the Mask bit is a 1, then the least significant bit is masked, and the value stored in the least significant bit indicates whether more bits are masked. If the LSB is 0, then no additional bits are masked. If the LSB is 1, then the second LSB is masked, and the value stored in the second LSB indicates whether more bits are masked. For a substring of 16 bits, this can be represented as:

17′bxxxx_xxxx_xxxx_xxxx_0=the 16 bits are exact match;

17′bxxxx_xxxx_xxxx_xxx0_1=the 15 MSBs are an exact match and the LSB is masked;

17′bxxxx_xxxx_xxxx_xx01_1=the 14 MSBs are an exact match and the two LSBs are masked;

17′bxxxx_xxxx_xxxx_x011_1=the 13 MSBs are an exact match and the three LSBs are masked;

. . .

17′b0111_1111_1111_1111_1=all bits are masked.

### Tracking Only the Most Superset Overlapping Rule

When subset non-overlapping rules are searched first followed by superset overlapping rules, there can only be one rule that has a given number of bits masked that overlaps its subset rule. For example the rule AAAA can only have one LPM rule that overlaps it and has 4 bits masked—rule AAA*. Thus, the total number of overlapping rules for a particular subset rule is limited to the size of the substring. As was outlined in a previous section, a bit wise mask can keep track of the superset overlapping rules. For example, if a rule table contains the rules AAAA, AAA*, and AA**, then the subset rule AAAA can have a bit mask associated with it that indicates bits 8 and 4 are the MSBs of two superset overlapping rules. Note that there is no ambiguity about what the actual rules are—the only rule that can overlap rule AAAA and have 4 bits masked is the rule AAA*, and the only rule that can overlap rule AAAA and have 8 bits masked is the rule AA**.

FIG. 22 is a diagram depicting a hierarchical search approach where a subsequent substring tree contains all the rules that overlapped each other in a previous substring. For example, if a rule table contained the rules AAAA_BBBB, AAA*_CCCC, and AA**_DDDD, then the tree that is pointed to by the rule AAAA must contain all three of the rules. This is required in order to correctly identify that the search string AAAA_CCCC matches the rule AAA*_CCCC and that the search string AAAA_DDDD matches the rule AA** DDDD.

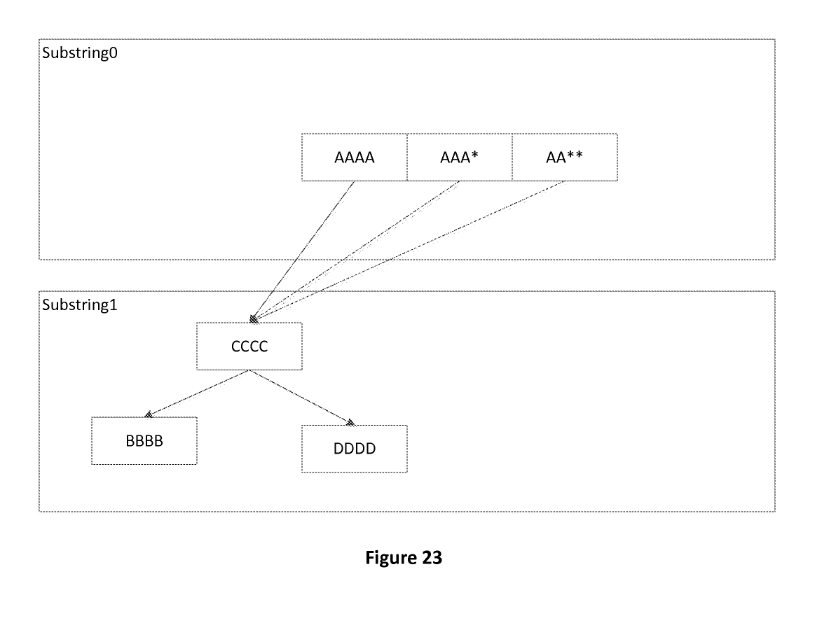

FIG. 23 is a diagram depicting the merger of overlapping rules into a single tree. There are two observations that can be made in from the table of FIG. 22. One is that all rules that are superset overlapping rules have their second substring copied multiple times in the second substring table. This can result in a variable and unpredictable amount of storage required to store rules since the amount of storage needed to store a rule depends on its overlap with other existing rules. Additionally, one rule can end up being copied several times and thus require a lot more storage. Rather than make multiple copies, the system disclosed herein may merge all the trees of overlapping rules into a single tree in order to reduce this storage overhead. Instead of having a separate tree pointed to by the overlapping rules AAA* and AA**, the trees are merged with the subset rule tree to result in a more optimized database. Note that the pointers from rule AAA* and AA** are not necessary since they point to the same tree as rule AAAA.

Once the pointers from the superset overlapping rules are pointing to the same tree as the subset rule, it can be noted that nothing is gained by keeping track of all the intermediate superset overlapping rules. In the above example, if rule AAAA matches and rule AA** matches, then rule AAA* must match as well. Therefore there is no reason to keep track of any intermediate superset overlapping rule. In fact, the only reason to keep track of any superset overlapping rule at all is to determine whether a search string has bits that mismatch in the exact match bits of the superset overlapping rule. For example, with the above rules AAAA_BBBB, AAA*_CCCC, and AA**_DDDD, if only track of the rules AAAA (rule 1) and AA** (rule 3) is kept, then it can be determined that a search string ABAA does not match any of the rules, but search string AABB does match rule 3 in the first substring. Thus, by just keeping track of the most superset overlapping rule, the system can further reduce the storage overhead associated with overlapping rules, and can make the storage requirements more predictable regardless of a rule's interaction with other rules in the table.

It should be noted in the above example that a search string AABB_CCCC would incorrectly match rule 2 (AAA*_CCCC) because additional information has not been passed on about what matched in the first substring to the second substring. This capability is added by Stage 3 of the system.

### Partitioning RAMs Hierarchically

When a high performance search is to be performed on a large rule table it is important to achieve the performance requirements with the least amount of memory overhead. The highest bandwidth that can be achieved is limited by the clock frequency at which the memory can be accessed. For a single ported memory, the fastest that a search can be performed without making copies of the rule tables is if the search requires one access per memory. The system described herein partitions the rules such that each substring of the hierarchical search is mapped to a different memory. Within a substring, a hierarchical search requires multiple accesses in order to find a matching entry. For a table that contains n rules (where n is one rule less than a power of 2), the worst case number of accesses required to find a rule is log₂(n) and the average number of accesses is log₂(n)−1. By mapping multiple levels of hierarchy into the same memory location, the number of accesses can be further reduced. If m levels of hierarchy are mapped into a single location, the worst case number of accesses can be reduced to log₂(n)/m. If this number is greater than one, then there is further scope to improve bandwidth by reducing the number of accesses per memory. The system described herein achieves this by mapping different levels of the hierarchy into different memories. Additionally, since the number of rules in the hierarchy start off small at the top of the tree and increase towards the bottom of the tree, the memories can be sized accordingly. For example, if a table contains 4K rules and 3 levels of hierarchy are mapped into one memory location, the memories can be sized as 1 location, 8 locations, 64 locations, and 512 locations. In practice, the smaller memories can be made a little larger in order to accommodate for memory fragmentation and rule expansion if it occurs.

### Processing ACL Configured Substrings

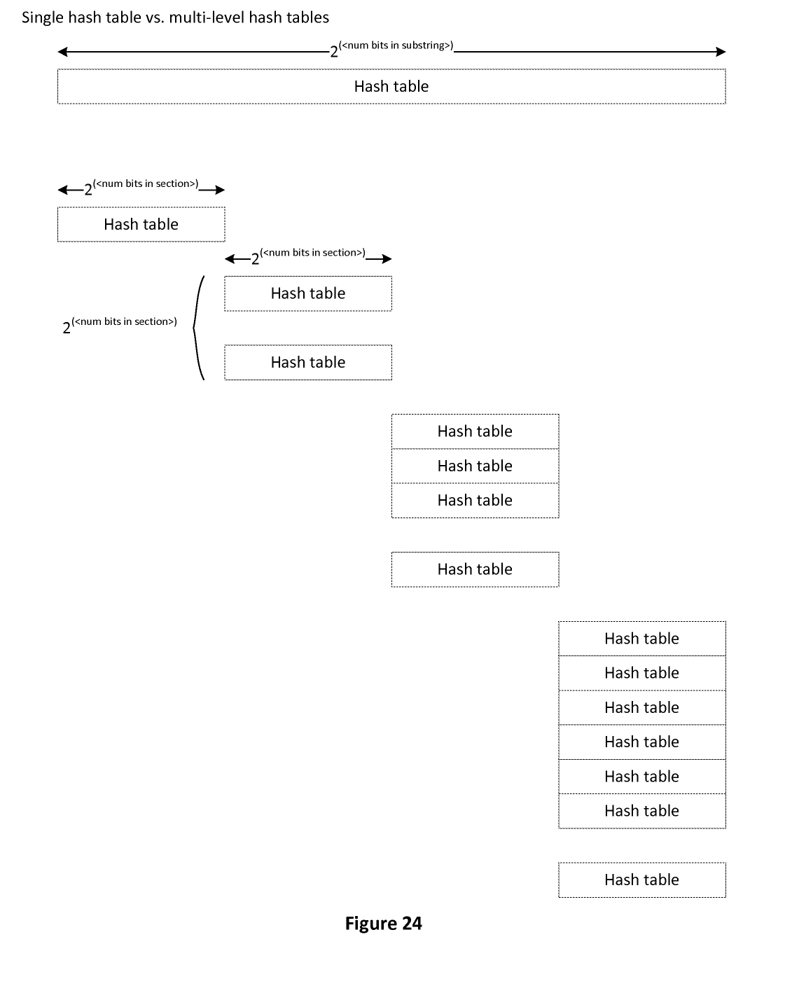

FIG. 24 is a diagram depicting multi-level hashing. Substrings configured as ACL (random wildcards) are processed using a different technique because the random nature of the mask bits makes these rules difficult to order in any fashion. A common technique used in the prior art is hashing, since hashing does not require any ordering of the rules. However, hashing can result in excessive overhead if the hash key is large. For example, if the hash key is 16 bits, the hash table will require sixteen thousand entries. Additionally, rules that have multiple wildcard bits will map to multiple hashed values, and thus result in excessive replication. Hashing also only works well if the rules are evenly distributed across all the encodings. Another issue with hashing is selecting a good hash function. When rules have non-contiguous and random wildcards, the hash function may result in even greater rule replication. To get around these problems the system described herein may use a multi-level hash for the second stage. Instead of creating a hash over the entire substring, the system may split the substring into smaller sections and create a recursive hash over successive sections. For example, in one realization of the system, the substring could be 16 bits wide and the hash sections may be 4 bits wide. Thus, instead of having a hash table that has sixteen thousand entries, it can be divided it into four successive tables.

### Compact Representation of Mask Bits in ACL Rules

ACL rules have the added complexity that any bits can be masked within the rule, and just like in the LPM case, the typical way of storing this information is to use two bits per one bit of rule. However, the system disclosed herein recognizes that in an ACL rule, each bit can have 3 values, a 0, a 1, or a don't care. The total number of unique values that a substring of n bits can take is 3ⁿ. For example, a substring of 8 bits will have 38 bits, or 6561 unique encodings. These 6561 unique values can be represented using log₂(6561)=13 bits, instead of the 16 bits needed if the typical way of storing is utilized.

While the worst case overall entries with the multi-level hashing scheme is the same as that of a single hash table, in most cases the table size is much smaller if the rule table is sparse or the rules are not evenly distributed across all encodings.

### Stage 3: Consolidate Results and Select Best Matching Rule

When rules consist of multiple tuples and are divided into substrings, it is necessary to include information about which rules matched within a substring in order to find the correct matching rule, and also to identify which rule to select when multiple rules match the search string. For example, in a table containing the rules AAAA_BB** and AA**_BBBB, some additional information about which of the overlapping rules matched in the first substring and which of the overlapping rules matched in the second substring is needed. This information is necessary in order to determine that a search string AAAA_BBBB matched both rules, and a search string AAFF_BBFF did not match either rule, even though substring AAFF individually matches AA** and substring BBFF individually matches BB**. In the bit map vectoring technique, this is accomplished by having each substring set a bit corresponding to all the rules that match that substring. If a table contains the rules AAAA_BB** (Rule0) and AA**_BBBB (Rule1), then the bit vector for the search string AAFF_BBFF has bit 1 set for the first substring. This allows the design to determine that the string matched AA** and not AAAA in the first substring. Similarly, the bit vector for the second substring has bit 0 set and not bit 1. This allows the design to determine that the string AAFF_BBFF does not match either of the rules, and also allows the design to determine the string AAAA_BBBB matches both rules.

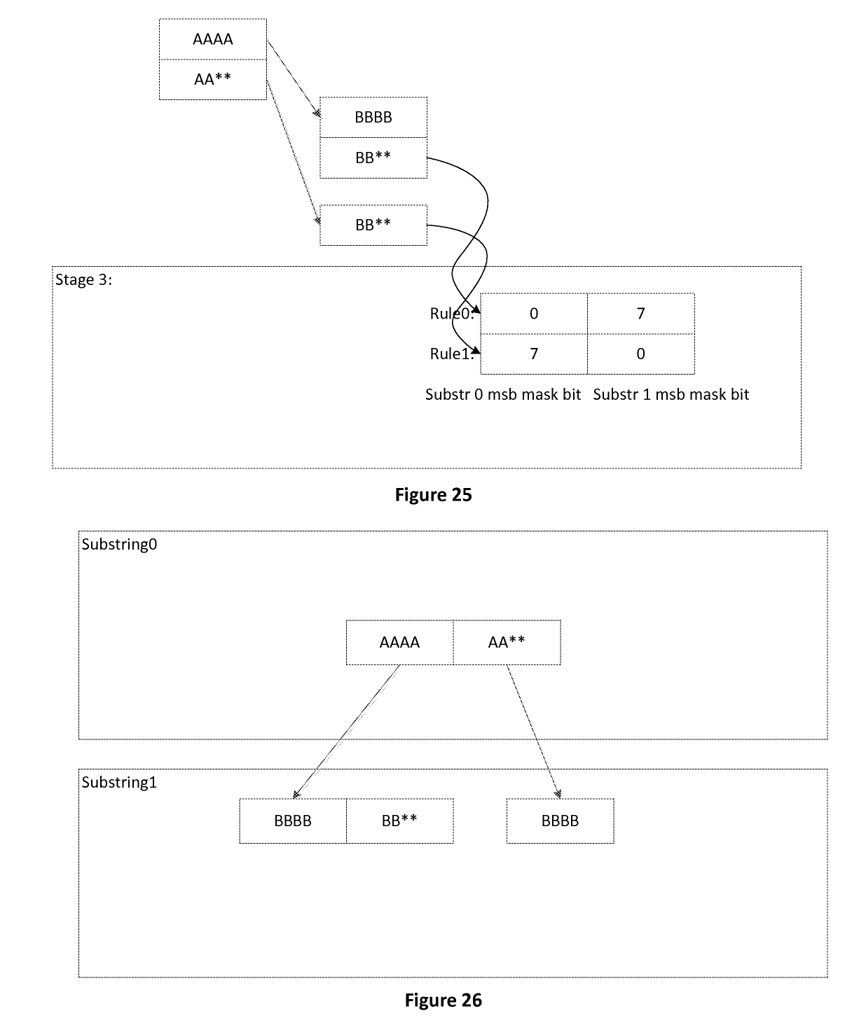

FIG. 25 is a diagram depicting the process of reconciliation. As outlined above, the bit map vectoring technique has the disadvantage of not scaling as the number of rules in the table increases. The system disclosed herein realizes the same functionality by adding a third stage where a per-substring field indicates exactly which bits are masked for a particular rule. It can be noted that after Stage 2 of the processing, the encoding of the exact match bits that match the current search string, and the bits that were masked have already been determined. This information can be used to reduce the amount of information required to find the matching rules in Stage 3.

For example, if a table contains the rules AAAA_BB** and AA**_BBBB, then after the Stage 2 processing, it is known that a search string AAAA_BBBB matched all exact match bits in both substrings. Similarly, it is known that a search string AAFF_BBFF matched the 8 exact match MSBs in the first substring, and matched the 8 exact match MSBs in the second substring. Since Stage 2 of the processing separates out all rules that are non-overlapping from this tree, the unmasked bits in all the rules are already known, and all that needs to be determined in Stage 3 is which bits are masked and which are unmasked. In the above example, any rule that did not contain AA in the most significant byte would not have traversed this tree, and any rule that matched AA** in the first substring, but did not contain BB in the most significant byte of the second substring, would also not have traversed this tree. Thus, Stage 3 only needs to identify which of the bits are masked and which are not.

For an LPM substring of n bits, the number of bits needed to identify all possible Stage 3 encodings is log₂(n)+1. For example, a substring of 16 bits needs 5 bits to identify all possible encodings of masked and unmasked bits, as follows: all bits are unmasked, the LSB is masked, the 2 LSBs are masked, . . . , all 16 bits are masked=17 possible encodings.

For an ACL substring of n bits, the number of bits needed to identify all possible Stage 3 encodings is n. For example, a substring of 4 bits needs 4 bits to identify all possible encodings of masked and unmasked bits, as follows: all bits are masked, the LSB bit is unmasked, the 2^{nd} bit is unmasked, the 3^{rd} bit is unmasked, the 4^{th} bit is unmasked, the 2 LSBs are unmasked, the middle 2 bits are unmasked, . . . , all bits are unmasked=1+4+6+4+1=16 possible encodings.

In all practical implementations of search tables, the number of rules in the table is much larger than the rule size. Therefore, the amount of storage required in Stage 3 of the system is O(number of rules) for Stage 2 and O(number of rules) for Stage 3.

FIG. 26 is a diagram presenting another example of overlapping LPM rules. The subset rule AAAA_BBBB has two superset rules AAAA_BB** and AA**_BBBB. Note that AA**_BBBB is a superset overlapping rule in Substring0 and AAAA_BB** is a superset overlapping rule in Substring1.

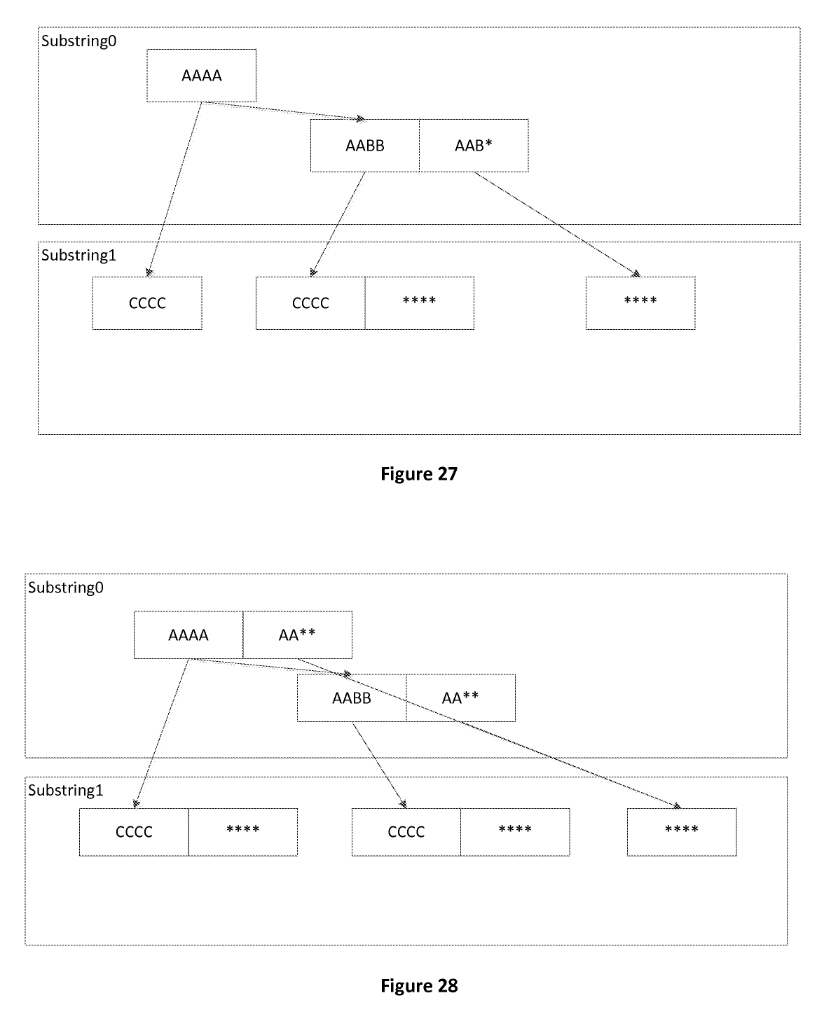

FIG. 27 is a diagram depicting an example of two non-overlapping LPM rules—AAAA_CCCC and AABB_CCCC, and one more rule AAB*_**** that overlaps rule AABB_CCCC. The non-overlapping rules are arranged in an AVL tree and searched first.

FIG. 28 is a diagram showing an example of one rule that overlaps two rules. Rule AA***_**** overlaps rule AAAA_CCCC and AABB_CCCC since AA** overlaps both AAAA and AABB. The non-overlapping rules are arranged in an AVL tree and searched first.

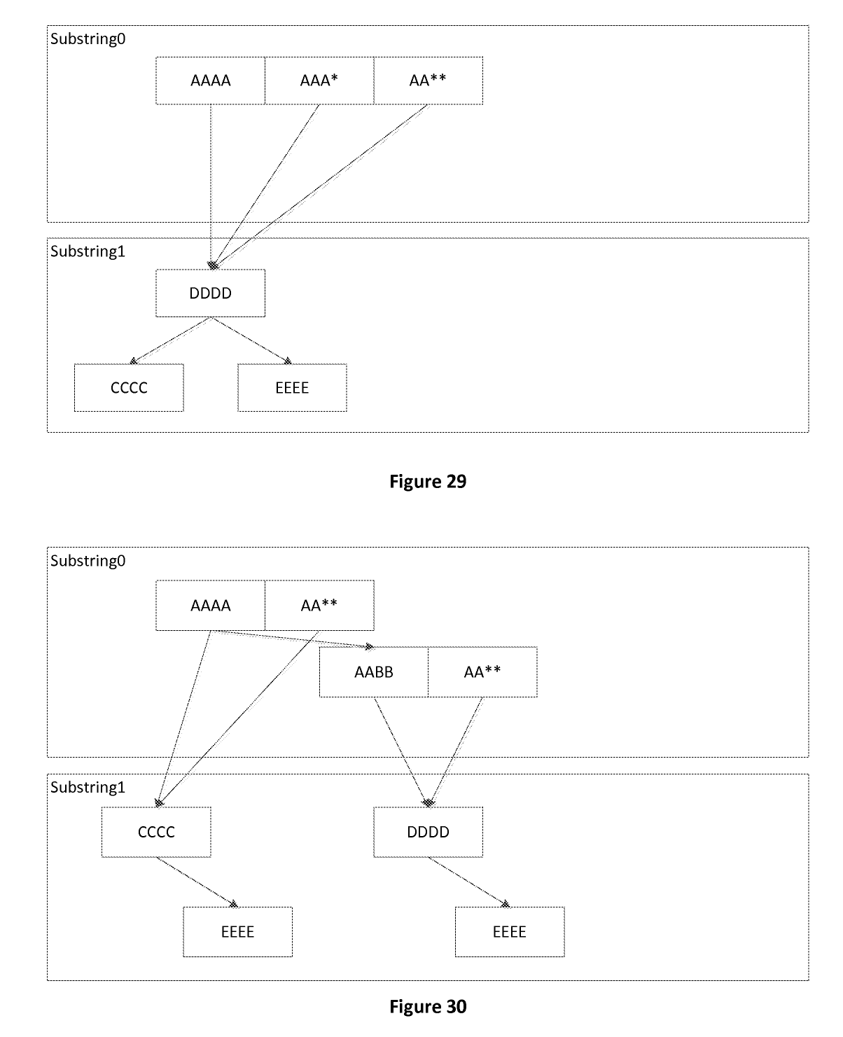

FIG. 29 is a diagram depicting the merger of superset pointers made in order to reduce rule expansion. Since the superset overlapping rules always get copied to their subset rule subtrees, the pointers can be merged to point to the same subtree so that the rules do not get copied. Here, the subset rule is AAAA_CCCC, and the superset overlapping rules are AAA*_DDDD and AA**_EEEE.

FIG. 30 depicts an example of a table that has a superset overlapping rule (AA**_EEEE) that overlaps two non-overlapping rules (AAAA_CCCC and AABB_DDDD in the first substring. The above optimization of merging pointers in order to reduce expansion also creates some problems with determining exactly which rule matched the search string. For example, if the rules in the table are AAAA_BBBB and AA**_**** and the search string is AABB_BBBB, then it would incorrectly match rule AAAA_BBBB because when comparing Substring1 there would be no way to know whether the string matched AAAA or AA** in Substring0.

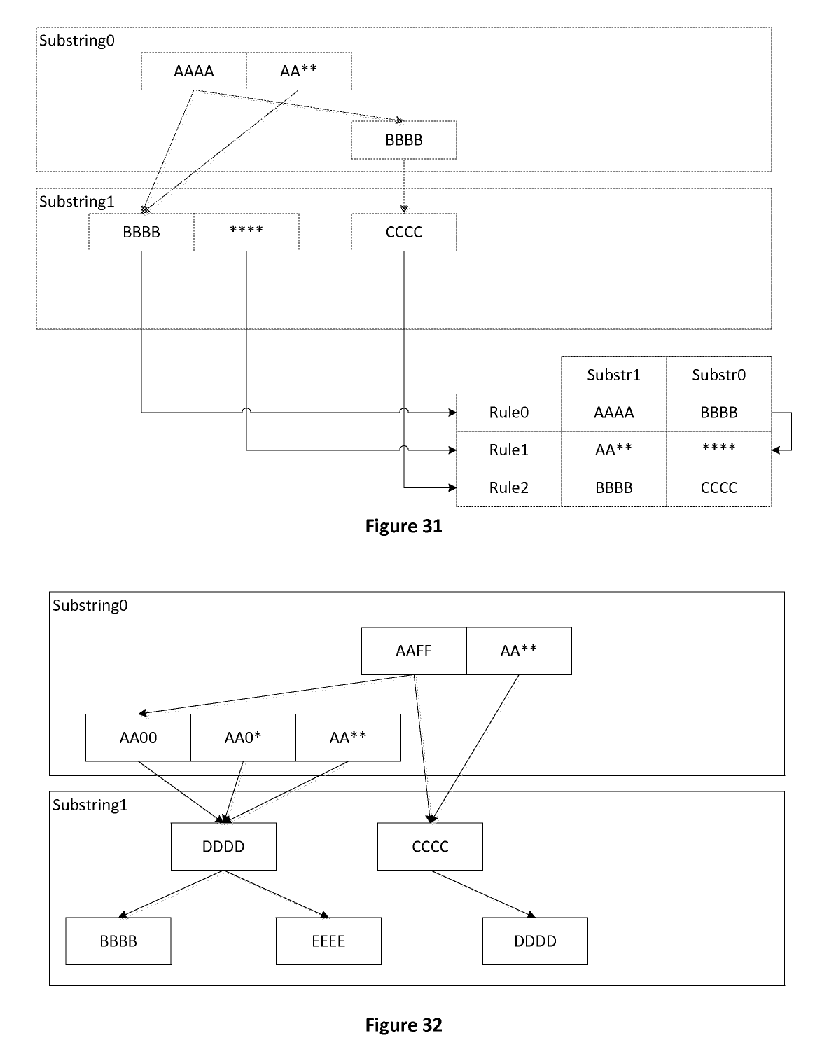

FIG. 31 is a diagram depicting another example of an exemplary third stage process that avoids the use of bit map vectoring. Since passing a bit vector from one substring to another is “expensive”, the system disclosed herein uses a third stage that achieves the same result but without the bit vector. The third stage can keep track of the original rule that can be matched to the search string. Since the second stage has narrowed down the rules to only those that overlap each other, the third stage finds all rules that may match the search string. This allows not only the highest priority rule that matched to be reported, but also all rules that matched the search string. In this example the rules are AAAA_BBBB, AA**_**** and BBBB_CCCC and the search string is AABB_BBBB. The search process takes the pointer from BBBB in Substring1 to the reconciliation stage and compares Rule0 to the search string. Since AAAA does not match AABB, this rule does not match the search string. The search process then examines the overlapping rule from Rule0 and recognizes that Rule1—AA**_**** does match the search string AABB_BBBB, and hence is the correct matching rule. Note that in this example, all non-overlapping rules had be separated out from the search process in Stage 2 itself, so Stage 3 only needs to examine the set of rules that overlapped each other and may match the search string.

At each subset non-overlapping rule, the following comparison is made in order to determine whether the rule matches the search string or not.

### Comparison Inputs:

Stored_Data—These are the exact match bits of the rule;
Stored_Mask—These are the mask bits of the rule;
Search_Data—This is the search string that should be compared to all rules that are stored in the table.
Comparison is as follows:
TermA=Stored_Data & Stored_Mask;
TermB=Search_Data & Stored_Mask.

If TermA equals TermB, then the current rule matches the search data. If TermA is greater than TermB, then the search goes to the right AVL subtree. If TermA is less than TermB, then the search goes to the left AVL subtree.

FIG. 32 is a diagram depicting ambiguity that is possibly created by searching for all subset rules prior to searching for superset rules. When subset rules are compared before superset rules, it is possible that certain search strings may not find a match in the subset non-overlapping rules table, even though a matching rule does exist because the matching rule is a superset rule.

In this example, Rule0 is AA00_BBBB, Rule1 is AAFF_CCCC, Rule2 is AA**_DDDD, and Rule3 is AA0*_EEEE. If the first search substring is AA0F, it would not match either of the subset rules AA00 or AAFF. However, it does match the substring AA**, which is a superset rule. In order to reliably find this rule, the search process must find the correct associated subset rule. In this example, the search string AA0F must be able to determine that the subset rule AA00 is associated with the matching superset rule and not the subset rule AAFF. It can determine that by selecting the rule that has the most matching MSBs with the search rule. For example, the rule AA00 has 12 MSB bits that match the search string, whereas the string AAFF only has 8 MSBs that match the search string. Therefore, the superset rules pointed to by substring AA0F should be processed in order to find the matching rule AA0*. The following logic shows how the right superset overlapping rule can be found.

The following comparison is made in order to find the most overlapping rule:

Most_Overlap rule=Root of tree;
Check_Overlap=Stored_DatâSearch_Data;
If(Check_Overlap<Most_Overlap),

Most_Overlap=Check_Overlap.

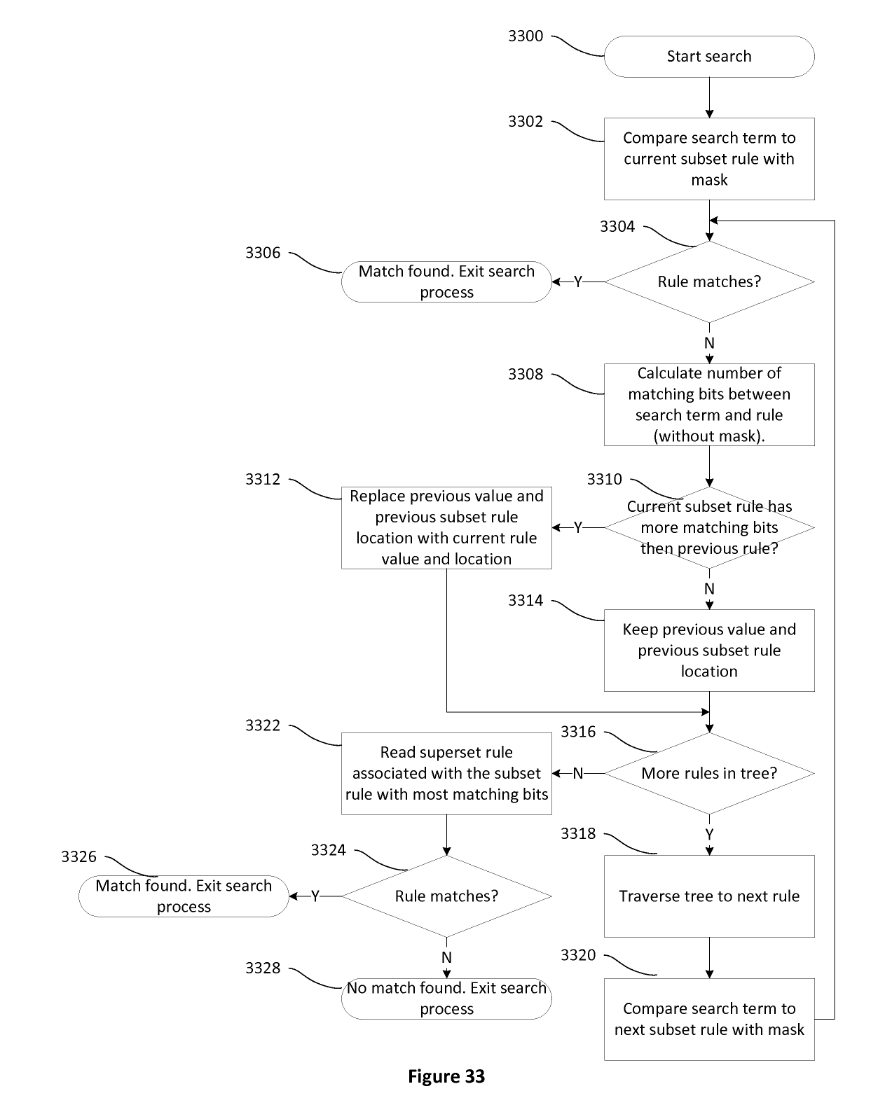

FIG. 33 is a first flowchart illustrating a method of searching for a multi-field LPM in a search term. The method begins at Step 3300. In Step 3302 the search term (search string) is compared to a current subset rule without masking. In Step 3304 a determination is made if the subset rule matches. If the answer is yes, the method goes to 3306 and the search is finished (or continues on to the next field in the search term). If the answer is no, the method goes to Step 3308 where the number of explicitly matching bits (symbols) between the search term and the (non-masked) subset rule is calculated. In Step 3310 a determination is made as to whether the current rule includes more matching bits than the previous most matching subset rule. If the answer is yes, the method moves to Step 3312 and the previous most-matching rule is replaced with the current subset rule, and the method continues to Step 3316. If the answer is no, the previous most-matching subset rule is retained. Step 3316 determines if there are more subset rules in the sorted search tree. If the answer is yes, the method traversed the tree to the next (new current) subset rule. Step 3320 compares the search term to the new current subset rule and continues to Step 3304. If the determination in Step 3316 is no, the method goes to Step 3322 where the superset rule (if any) associated with the most matching subset rule is read. In Step 3324 a determination is made if the superset rule matches the search term. If the answer is yes, the method goes to Step 3326, which indicates that a matching rule has been found. If the answer is no, the method goes to Step 3328 indicating that no rules match the search term.

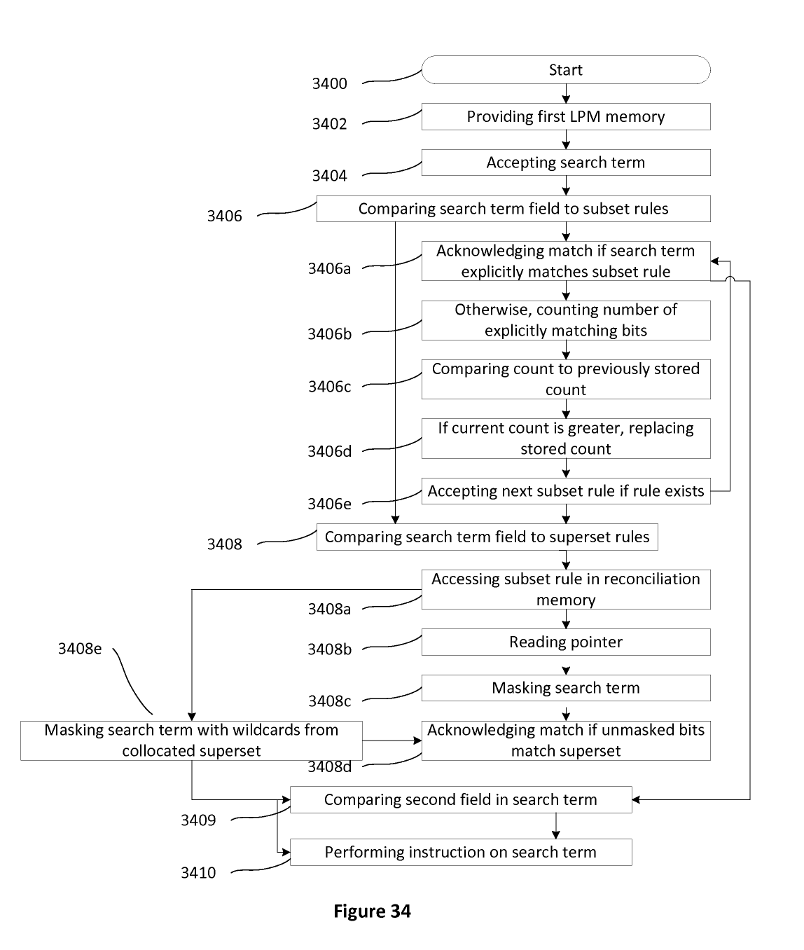

FIG. 34 is a second flowchart illustrating method of searching for a multi-field LPM in a search term. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 3400.

Step 3402 provides a non-transitory first LPM rule memory, which is also referred to as a table or first LPM rule table. As explained above, an LPM rule includes explicitly defined bit values in at least the n most significant bit positions in a field of digital information, where n is an integer greater than or equal to 0. Step 3404 accepts a search term, which may also be referred to as a search string. Step 3406 compares at least a first field in the search term to subset rules structured in a sorted search tree for a first field organized as a LPM rule in the first LPM memory. As explained in detail above, a subset rule is defined by a substring with at least one explicitly specified digital value that distinguishes the substring from every other rule substring in the first LPM memory. When an explicit match is not found to the subset rules, Step 3408 compares the first field in the search term to superset rules for the first field in the first LPM memory. As above, a superset rule is defined as a substring with a least one wildcard more than an associated subset rule, and having a digital value overlapping the associated subset rule digital value, where a wildcard may be any digital value. Step 3410 performs an instruction associated with a matching rule.

In one aspect, Step 3402 provides a first subset rule populating the first LPM memory, which has a digital value overlapping a first superset rule. The first subset rule and first superset rule have associated locations in the first LPM rule memory. Step 3402 also provides (e.g., populates the first LPM memory with) a second subset rule having a digital value overlapping the first superset rule, where the second subset rule and first superset rule have associated locations in the first LPM rule memory. Typically, the first LPM memory includes a plurality of subset rules. It is also typical that there is a plurality of superset rules. However, not every subset rule need be associated with a superset rule. In another aspect, Step 3402 provides a second superset rule having at least one more wildcard than the first superset rule, where the second superset rule and first superset rule have associated locations in the first LPM rule memory. Many, but not all, subset rules may be associated with more than one superset rule.

In one variation, the first subset rule resides at a first location in the first LPM memory, and is represented as a first mask word with explicitly defined digital values and the position of wildcards in the first subset rule, with a pointer directed to a second location. In this case, the first superset rule resides at the second location in the first LPM memory, and is represented as a second mask word with explicitly defined digital values and the position of wildcards in the first superset rule. To continue the example, the second subset rule may reside at a third location in the first LPM memory, represented as a third mask word with explicitly defined digital values and the position of wildcards in the second subset rule, with a pointer directed to a fourth location. The first superset rule resides at the fourth location in the first LPM memory, represented as a second mask word with explicitly defined digital values and the position of wildcards in the first superset rule. In one aspect, the pointers in the first and third locations may be directed to a common first superset location in the first LPM memory.

In an alternative variation, Step 3402 collocates the first subset rule and first superset rule in a first LPM memory location, represented as a first mask word with explicitly defined digital values and the position of wildcards in the first subset rule and the first superset rule. Likewise, Step 3402 collocates the second subset rule and first superset rule in a second LPM memory location, represented as a second mask word with explicitly defined digital values and the position of wildcards in the second subset rule and the first superset rule.

In one aspect, comparing the search term to the subset rules in Step 3406 includes substeps. Step 3406a acknowledges a matching rule when all bits in the search term match the explicitly defined bits in a subset rule. When all the bits in the search term fail to match the explicitly defined bits in a first subset rule Step 3406b counts the number of explicitly matching bits to create a current count. Step 3406c compares the current count to a previously stored count. When the current count is greater than the previously stored count, Step 3406d replaces the previously stored count with the current count and stores the first subset in a reconciliation memory. Step 3406e accepts a next subset rule in the first LPM rule memory AVL tree for comparison to the search term.

In another aspect, comparing the first field in the search term to superset rules in Step 3408 includes substeps. Subsequent to comparing all the subset rules in the first LPM memory to the search term and not finding a match, Step 3408a accesses the subset rule in the reconciliation memory. Step 3408b reads a pointer directed to an associated superset rule. Step 3408c masks the search term with wildcards from the associated superset rule, and when the unmasked bits in the search term match the associated superset rule, Step 3408d acknowledges the associated superset rule as the matching rule.

In a different aspect, Step 3408 includes different substeps. Step 3408e masks the search term with wildcards from a collocated superset rule. When the unmasked bits in the search term match the collocated superset rule, Step 3408d acknowledges the collocated superset rule as the matching rule.

In another aspect, Step 3402 provides a non-transitory second LPM rule memory comprising subset rules structured in a sorted search tree for a search term second field organized as a LPM rule, and superset rules for the second field. Subsequent to comparing the first field of the search term, Step 3406 compares a second field in the search term to subset rules in the second LPM memory. When an explicit match is not found to the subset rules in the second LPM rule memory, Step 3409 compares the second field in the search term to the superset rules in the second LPM memory. Then, Step 3410 performs instructions associated with the matching rule found in the second LPM memory. Although only two search term fields are described in this flowchart, it should be understood that the method is not necessarily limited to may particular number of fields or LPM memories.

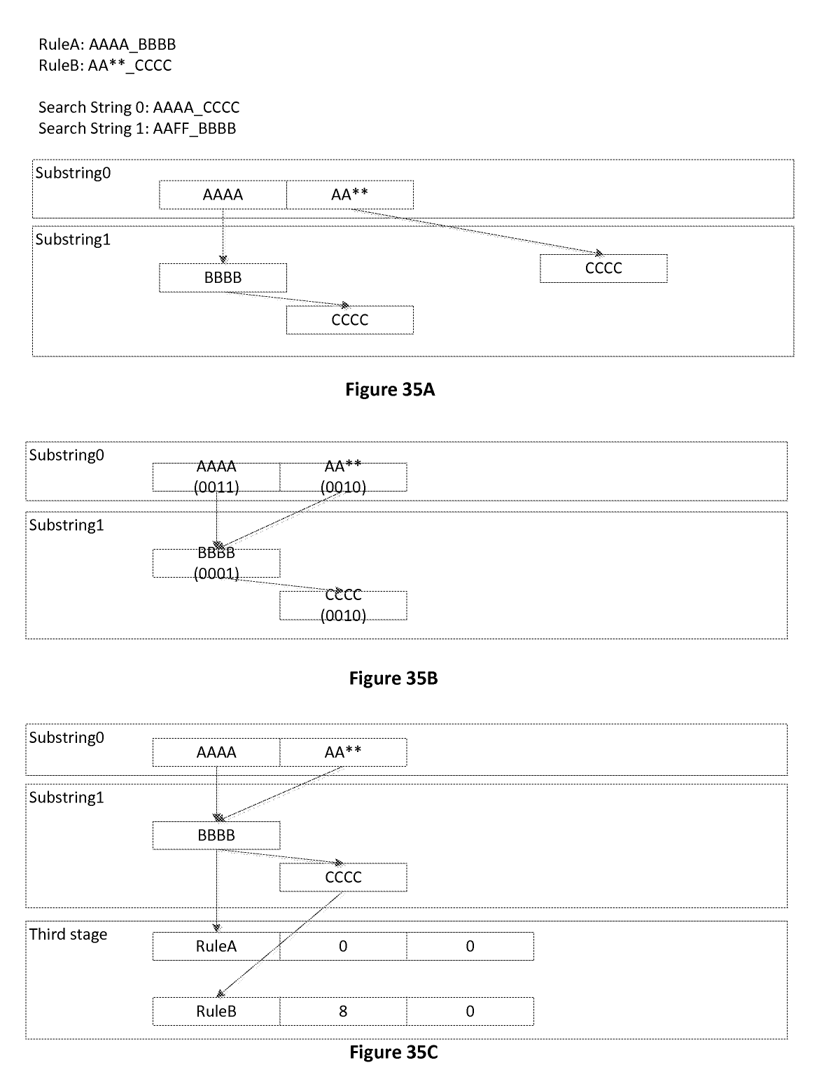

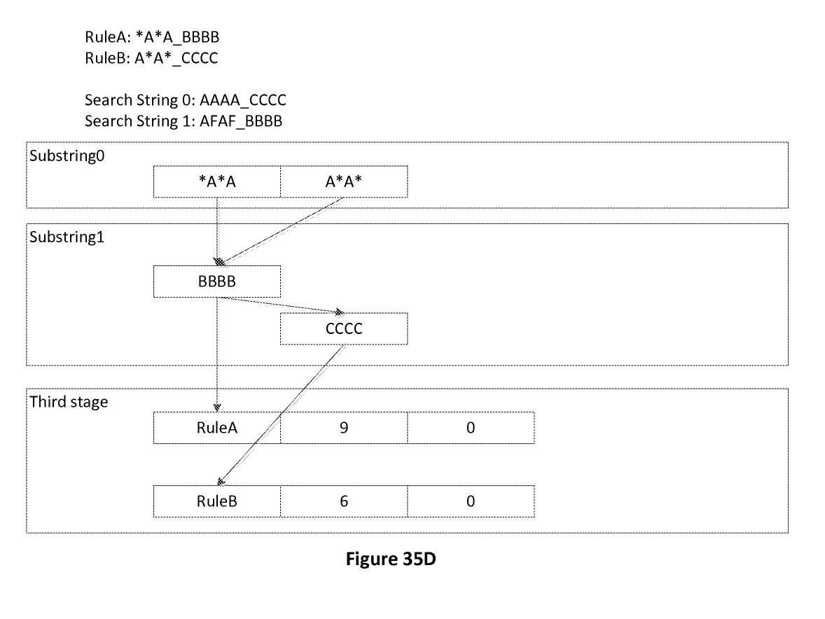

FIGS. 35A through 35D are examples depicting the benefit of third stage processing. In FIG. 35A Rule A is AAAA_AA** and Rule B is AA**_CCCC. The first field of the two rules overlaps. Search String 0 is AAAA_CCCC and Search String 1 is AAFF_BBBB. Search String 0 matches Rule B, but Search String 1 does not match either rule. One method of handling overlapping rules is to create a separate tree from each superset overlapping rule, as shown. However, this method would result in rule expansion because the same rule (CCCC) is copied.

As shown in FIG. 35B, another method creates a per rule and a per substring bit vector that is passed from one substring to the next. This method permits the correct matching rule to be determined at the final stage. In this example AAAA has both bits 0 and 1 set in its bit vector because AAAA matches both Rule A and Rule B. AA** has only bit 1 set because it only matches Rule B. Similarly, BBBB has bit 0 set because it matches Rule A, and CCCC has bit 1 set because it matches Rule B.

When the search string is AAAA_CCCC, the two bit vectors from each substring are:

AAAA: 0011

CCCC: 0010.

A bitwise AND function determines that only bit 1 is set in both substrings. Therefore, only Rule A matches this search string.

When the search string is AAFF_BBBB, the bit vectors from each substring are:

AAFF: 1101

BBBB: 0001.

A bitwise AND function determines that neither rule has any (common) bits set in both substrings. Therefore, neither rule matches the search string. This technique does not scale well when the number of rules is large or the search string is large, because it results in the creation of large bit vectors.

As disclosed herein, a third stage of searching can be used instead of passing bit vectors. Rather than passing a bit vector, the number of bits that matches in the substring is passed down. Note that is this case the number of bits passed from one substring to the next is bound by the size of the substring unlike the bit vector technique where the number of bits passed from one substring to the next is the size of the number of rules. This reconciliation stage resolves the problem of rule expansion by keeping track of how many bits are masked per substring.

As shown in FIG. 35C, when the search string is AAAA_CCCC, the first substring passes down a 0 because AAAA matches all bits for a rule in substring 0. The second substring passes down a 0 because CCCC matches all bits for a rule in substring 1. Since the third stage indicates that Rule B has up to 2 bits masked in substring 0, which is greater than the 0 bits passed down for this rule in substring 0, and the 0 bits masked in substring 1, which is equal to the 0 bits passed down for this rule in substring 1, it is known that Rule B matches search string AAAA_CCCC.

When the search string is AAFF_BBBB, the first substring passes down an 8 because AAAA does not match, but AA** does match in substring 0. The second substring passes down a 0 because BBBB matches all bits for a rule in substring 1. Since the third stage indicates Rule A has 0 bits matching in substring 0, which is less than the 2 passed down for this rule for substring 0, it is known that Rule A does not match the search string AAFF_BBBB.

FIG. 35D depicts an example of reconciliation as applied to ACL rules, where the placement of wildcards is random and not constrained to any particular order. One difference between ACL rules and LPM rules is the number of overlaps possible. In LPM rules the possible overlaps are:

AAAA (0)

AAA* (1)

AA** (2)

A*** (3)

**** (4).

Thus, if a substring is 4 bits, the number of overlaps possible is (4+1), and the number of bits needed to identify all overlapping rules is log₂(4+1).

With ACL rules the possible overlaps are:

AAAA (0)

AAA* (1)

AA*A (2)

A*AA (3)

*AAA (4)

AA** (5)

A*A* (6)

A**A (7)

*AA* (8)

*A*A (9)

**AA (A)

A*** (B)

*A** (C)

**A* (D)

***A (E)

**** (F).

Thus, if the substring is 4 bits, the number of possible ACL overlapping rules is 2⁴=16, and the number of bits needed to identify all possible overlapping rules is log₂ (16)=4.

The above-described method may be enabled in hardware or at least partially as a computer-readable medium. As used herein, the term “computer-readable medium” refers to any medium that participates in providing instructions to a processor for execution. Such a medium may take many forms, including but not limited to, non-volatile media, volatile media, and transmission media. Non-volatile media includes, for example, optical or magnetic disks. Volatile media includes dynamic memory. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

A system and method have been provided for optimizing LPM search accessing. Examples of particular message structures, processes steps, and hardware units have been presented to illustrate the invention. However, the invention is not limited to merely these examples. Other variations and embodiments of the invention will occur to those skilled in the art.

We claim:

1. A memory system organized for optimized multi-field longest prefix match (LPM) search accessing, the system comprising:
a non-transitory first LPM rule memory, where an LPM rule includes explicitly defined bit values in at least the n most significant bit (MSB) positions in a field of digital information, where n is an integer greater than or equal to 0, the first LPM rule memory comprising:
subset rules structured in a sorted search tree for a first field organized as a LPM rule, where a subset rule is defined by a substring with at least one explicitly specified digital value that distinguishes the substring from every other rule substring in the first LPM memory; and,
superset rules for the first field, where a superset rule is defined as a substring with a least one wildcard more than an associated subset rule, and having a digital value overlapping the associated subset rule digital value, where a wildcard may be any digital value.

2. The system of claim 1 wherein a first subset rule has a digital value overlapping a first superset rule, and where the first subset rule and first superset rule have associated locations in the first LPM rule memory; and,
wherein a second subset rule has a digital value overlapping the first superset rule, and where the second subset rule and first superset rule have associated locations in the first LPM rule memory.

3. The system of claim 2 wherein the first superset rule has a digital value overlapping a second superset rule, the second superset rule having at least one more wildcard than the first superset rule.

4. The system of claim 2 wherein the first subset rule has a first location in the first LPM memory, represented as a first mask word with explicitly defined digital values and the position of wildcards in the first subset rule, with a pointer directed to a second location in the first LPM memory containing the first superset rule, represented as a second mask word with explicitly defined digital values and the position of wildcards in the first superset rule; and,
wherein the second subset rule has a third location in the first LPM memory, represented as a third mask word with explicitly defined digital values and the position of wildcards in the second subset rule with a pointer directed to a fourth location in the first LPM memory containing the first superset rule, represented as a fourth mask word with explicitly defined digital values and the position of wildcards in the first superset rule.

5. The system of claim 2 wherein the first subset rule and first superset rule are collocated in a first LPM memory location, represented as a first mask word with explicitly defined digital values and the position of wildcards in the first subset rule and the first superset rule; and,
wherein the second subset rule and first superset rule are collocated in a second LPM memory location, represented as a second mask word with explicitly defined digital values and the position of wildcards in the second subset rule and the first superset rule.

6. The system of claim 2 further comprising:
an expander having an input to accept a search term with a first field and an input to accept the first subset rule, the expander:
comparing the search term to the first subset rule, and acknowledging a matching rule when all bits in the search term match the explicitly defined bits in the first subset rule;
when all the bits in the search term fail to match the explicitly defined bits in the first subset rule:
counting the number of explicitly matching bits to create a current count;
comparing the current count to a previously stored count;
when the current count is greater than the previously stored count, replaces the previously stored count with the current count and storing the first subset in a reconciliation memory; and,
accepting a next subset rule in the first LPM rule memory for comparison to the search term.

7. The system of claim 6 wherein the expander, subsequent to comparing all the subset rules in the first LPM memory to the search term and not finding a match, accesses the subset rule in the reconciliation memory, reads a pointer directed to an associated superset rule, masks the search term with wildcards from the associated superset rule, and when the unmasked bits in the search term match the associated superset rule, acknowledging the associated superset rule as the matching rule.

8. The system of claim 6 wherein the expander, subsequent to comparing all the subset rules in the first LPM memory to the search term and not finding a match, accesses the subset rule in the reconciliation memory, masks the search term with wildcards from a collocated superset rule, and when the unmasked bits in the search term match the collocated superset rule, acknowledging the collocated superset rule as the matching rule.

9. The system of claim 1 further comprising:
a non-transitory second LPM rule memory comprising:
subset rules structured in a sorted search tree for a search term second field organized as a LPM rule; and,
superset rules for the second field.

10. A method of searching for a multi-field longest prefix match (LPM) in a search term, the method comprising:
providing a non-transitory first LPM rule memory, where an LPM rule includes explicitly defined bit values in at least the n most significant bit (MSB) positions in a field of digital information, where n is an integer greater than or equal to 0;
accepting a search term;
comparing at least a first field in the search term to subset rules structured in a sorted search tree for a first field organized as a LPM rule in the first LPM memory, where a subset rule is defined by a substring with at least one explicitly specified digital value that distinguishes the substring from every other rule substring in the first LPM memory;
when an explicit match is not found to the subset rules, comparing the first field in the search term to superset rules for the first field in the first LPM memory, where a superset rule is defined as a substring with a least one wildcard more than an associated subset rule, having a digital value overlapping the associated subset rule digital value, where a wildcard may be any digital value; and,
performing an instruction associated with a matching rule.

11. The method of claim 10 wherein providing the first LPM rule memory includes:
providing a first subset rule having a digital value overlapping a first superset rule, where the first subset rule and first superset rule have associated locations in the first LPM rule memory; and,
providing a second subset rule having a digital value overlapping the first superset rule, where the second subset rule and first superset rule have associated locations in the first LPM rule memory.

12. The method of claim 11 wherein providing the first LPM rule memory includes providing a second superset rule having at least one more wildcard than the first superset rule, where the second superset rule and first superset rule have associated locations in the first LPM rule memory.

13. The method of claim 11 wherein providing the first LPM memory includes:
providing the first subset rule at a first location in the first LPM memory, represented as a first mask word with explicitly defined digital values and the position of wildcards in the first subset rule, with a pointer directed to a second location;
providing the first superset rule at the second location in the first LPM memory, represented as a second mask word with explicitly defined digital values and the position of wildcards in the first superset rule;
providing the second subset rule at a third location in the first LPM memory, represented as a third mask word with explicitly defined digital values and the position of wildcards in the second subset rule, with a pointer directed to a fourth location; and,
providing the first superset rule at the fourth location in the first LPM memory, represented as a second mask word with explicitly defined digital values and the position of wildcards in the first superset rule.

14. The method claim 11 wherein providing the first LPM memory includes:
collocating the first subset rule and first superset rule in a first LPM memory location, represented as a first mask word with explicitly defined digital values and the position of wildcards in the first subset rule and the first superset rule;
collocating the second subset rule and first superset rule in a second LPM memory location, represented as a second mask word with explicitly defined digital values and the position of wildcards in the second subset rule and the first superset rule.

15. The method of claim 11 wherein comparing the search term to the subset rules includes:
acknowledging a matching rule when all bits in the search term match the explicitly defined bits in a subset rule;
when all the bits in the search term fail to match the explicitly defined bits in a first subset rule, counting the number of explicitly matching bits to create a current count;
comparing the current count to a previously stored count;
when the current count is greater than the previously stored count, replaced the previously stored count with the current count and storing the first subset in a reconciliation memory; and,
accepting a next subset rule in the first LPM rule memory for comparison to the search term.

16. The method of claim 15 wherein comparing the first field in the search term to superset rules includes:
subsequent to comparing all the subset rules in the first LPM memory to the search term and not finding a match, accessing the subset rule in the reconciliation memory;
reading a pointer directed to an associated superset rule;
masking the search term with wildcards from the associated superset rule; and,
when the unmasked bits in the search term match the associated superset rule, acknowledging the associated superset rule as the matching rule.

17. The method of claim 15 wherein comparing the first field in the search term to the superset rules includes:
subsequent to comparing all the subset rules in the first LPM memory to the search term and not finding a match, accessing the subset rule in the reconciliation memory;
masking the search term with wildcards from a collocated superset rule; and,
when the unmasked bits in the search term match the collocated superset rule, acknowledging the collocated superset rule as the matching rule.

18. The method of claim 10 wherein providing the first LPM memory includes providing a non-transitory second LPM rule memory comprising:
subset rules structured in a sorted search tree for a search term second field organized as a LPM rule; and,
superset rules for the second field;
the method further comprising:
subsequent to comparing the first field of the search term, comparing a second field in the search term to subset rules in the second LPM memory;
when an explicit match is not found to the subset rules in the second LPM rule memory, comparing the second field in the search term to the superset rules in the second LPM memory; and,
wherein performing the instruction includes performing instructions associated with the matching rule found in the second LPM memory.

19. A packet processing system organized for multi-field longest prefix match (LPM) search accessing, the system comprising:
a non-transitory first LPM rule memory, where an LPM rule includes explicitly defined bit values in at least the n most significant bit (MSB) positions in a field of digital information, where n is an integer greater than or equal to 0, the first LPM rule memory comprising:
subset rules structured in a sorted search tree for a first field organized as a LPM rule, where a subset rule is defined by a substring with at least one explicitly specified digital value that distinguishes the substring from every other rule substring in the first LPM memory;
superset rules for the first field, where a superset rule is defined as a substring with a least one wildcard more than an associated subset rule, having a digital value overlapping the associated subset rule digital value, and where a wildcard may be any digital value;
an expander having an input to accept a packet including a search term with a first field and an input to accept the first subset rule, the expander initially comparing the search term to the subset rules, and when all the bits in the search term fail to match the explicitly defined bits in the subset rules, comparing the search term to the superset rules; and,
a performance engine having inputs to accept the packet and the matching rule, and an output to supply the packet modified in response to instructions associated with the matching rule.

20. The system of claim 19 wherein the first LPM memory is organized in accordance with a structure selected from a group of collocated superset rules with associated subset rules, or creating pointers from subset rule memory locations to associated superset rule memory locations.
